(19) United States
(12) Patent Application Publication
(10) Pub. No.: US 2024/0041028 A1
(43) Pub. Date: Feb. 8, 2024

(54) DELIVERY SYSTEM FOR PLANT PROTECTION

(71) Applicant: Omya International AG, Oftringen (CH)

(72) Inventors: Hocine HELLAL, Füllinsdorf (CH); Fabien Wilhelm MONNARD, Aarburg (CH); Florentine Marianne HILTY-VANCURA, Meilen (CH); Evangelia PAPAGIANNAKI, Wettingen (CH)

(73) Assignee: Omya International AG, Oftringen (CH)

(21) Appl. No.: 18/258,293

(22) PCT Filed: Dec. 29, 2021
(86) PCT No.: PCT/EP2021/087807

§ 371 Date: Jun. 19, 2023

(30) Foreign Application Priority Data
Jan. 4, 2021 (EP) 21150008.7

(51) Int. Cl. A01N 25/08; A01P 7/04; A01P 13/00; A01N 31/14; A01N 37/38; A01P 3/00; A01N 43/54

(52) U.S. Cl. CPC A01N 25/08; A01P 7/04; A01P 13/00; A01N 31/14; A01N 37/38; A01P 3/00; A01N 43/54

(57) ABSTRACT

The present invention is directed to delivery system comprising a first hydromagnesite, wherein the first hydromagnesite is an unloaded hydromagnesite, and a second hydromagnesite, wherein the second hydromagnesite is loaded with at least one active agent.

The present application relates to a delivery system comprising a hydromagnesite composition being loaded with at least one active agent, an agricultural formulation comprising the same, the use of said delivery system in an agricultural application, and a method of preparing said delivery system.

Agrochemical compounds are widely used in agriculture to improve the cultivation of useful plants. Many of these agrochemical compounds are known as plant protection products which may be used to protect plants from damaging influences such as weeds, plant diseases or insects. Crop protection products may include, for example, bactericides, fungicides, acaricides, insecticides, molluscicides, nematicides, rodenticides, avicides, and herbicides. Another group of agrochemical compounds is used to promote or regulate plant growth and includes fertilizers, soil additives, micronutrients and phytohormones. In order to satisfy the needs of a constantly growing world population having a constantly growing demand for food, the use of agrochemical compounds has become indispensable.

However, many of the plant protection products are highly toxic and persistent in the environment, and thus, the use of such products raises a number of concerns. For examples, plant protection products can cause water pollution and soil contamination, reduce biodiversity or threaten endangered species. Furthermore, plant protection products may cause acute and delayed health effects in workers who are exposed and may result in contamination of the treated product, especially if they are not applied correctly. The use of plant protection products may also bear risks to the health and safety of consumers and to public safety. Such risks arise primarily from handling, i.e. the transfer between containers, use or application and storage of these products. Especially for professional use, plant protection products are often sold in form of concentrated liquids, which bear the risk of accidental splashes or inhalation of product vapours. Moreover, remnants of plant protection products and their packaging must be regarded as hazardous waste.

The overuse of fertilizers also can lead to negative environmental consequences such as pollution of rivers and lakes due to wash off nutrients abundant in fertilizers. For example, the increased amount of nutrients such as nitrates and phosphate promotes the grow of algae, which use up oxygen that fish and other aquatic animals need.

In view of the foregoing risk, there is a strong desire to reduce the use of agrochemical compounds by precise application and to minimize the risks in handling and disposal of such products. For example, the on-going development of precision farming techniques seeks to reduce the quantity of plant protection products used, as such techniques progress, and to improve the effectiveness of treatment. Techniques such as plant-by-plant spraying, strip spraying or reduced-dose spraying have become possible as a result of innovative application equipment. However, such techniques often require solutions that are applicable via spray nozzles without blocking them.

There is also a general desire to reduce packaging waste. Especially, agrochemical compositions that are sold for home gardening are often only available in diluted forms in order to reduce health risks for the consumer. Such diluted products, however, require bulky containers resulting in higher production and transporting costs and more packaging waste.

For example, US20120295790 A1 relates to a pesticidal composition comprising microcapsules which contain a pesticidal active ingredient and a suitable carrier and to a method of controlling pests comprising the application of an effective amount of such a pesticidal composition within a locus where pests are or are expected to be present. Said microcapsules exhibits sustained-release properties. Likewise, WO2010037753 A1 discloses a controlled release active agent carrier. Said carrier comprises a surface-reacted natural or synthetic calcium carbonate and one or more active agents. EP3045042 A1 relates to the use of a particulate solid carrier to enhance the efficiency of an agrochemical compound loaded onto said carrier, wherein the carrier comprises a surface-reacted calcium carbonate-containing mineral and/or a surface-reacted precipitated calcium carbonate.

However, there is still a need in the art for alternative and improved formulations of agrochemical compositions.

Accordingly, it is an object of the present invention, to provide an agrochemical composition which overcomes one or more of the afore-mentioned disadvantages. For example, it is an object of the present invention to provide an agrochemical composition which improves the user comfort and user safety. It would be desirable that the handling of the composition is safe and easily manageable. Furthermore, it would be desirable that the composition can be provided in a form which reduces packing waste and hazardous remnants.

Another object may be seen in the provision of an agrochemical composition that can deliver the agrochemical compound efficiently. It would also be desirable that formulations containing agrochemical compounds are enhanced to be equally efficient at lower overall costs. Furthermore, it would be desirable that the agrochemical compound can be precisely dosed. It would also be desirable that a sprayable solution or suspension can be produced from said agrochemical composition, which works with standard spraying equipment and does not block spraying nozzles.

The foregoing and other problems may be solved by the subject-matter as defined herein in the independent claims.

According to one aspect of the present invention, a delivery system is provided comprising a first hydromagnesite, wherein the first hydromagnesite is an unloaded hydromagnesite, and a second hydromagnesite, wherein the second hydromagnesite is loaded with at least one active agent.

According to a further aspect of the present invention, use of a delivery system according to the present invention in an agricultural application is provided.

According to still a further aspect of the present invention, an agricultural formulation comprising a delivery system according to the present invention is provided.

According to still a further aspect of the present invention, a method for preparing a delivery system according to the present invention is provided, wherein the method comprises the steps of:
a) providing a first hydromagnesite, wherein the first hydromagnesite is an unloaded hydromagnesite,
b) providing a second hydromagnesite, wherein the second hydromagnesite is loaded with at least one active agent,
c) mixing the first hydromagnesite and the second hydromagnesite, and
d) optionally compacting the mixture obtained in step c).

Advantageous embodiments of the present invention are defined in the corresponding subclaims.

According to one embodiment the first hydromagnesite and/or the second hydromagnesite has a specific surface area in the range from 25 to 150 m²/g, preferably from 35 to 120 m²/g, and most preferably from 35 to 100 m²/g, measured using nitrogen and the BET method according to ISO 9277:2010. According to another embodiment the first hydromagnesite and/or the second hydromagnesite has an intra-particle intruded specific pore volume in the range from 0.9 to 2.3 cm³/g, preferably from 1 to 2.1 cm³/g, and most preferably from 1.2 to 2.0 cm³/g, calculated from mercury porosimetry measurement. According to still another embodiment the first hydromagnesite and/or the second hydromagnesite has a volume determined median particle size d₅₀ from 1 to 75 μm, preferably from 1.2 to 50 μm, more preferably from 1.5 to 30 μm, even more preferably from 1.7 to 15 μm, and most preferably from 1.9 to 10 μm, and/or the first hydromagnesite and/or the second hydromagnesite has a volume determined top cut particle size d₉₈ from 2 to 150 μm, preferably from 4 to 100 μm, more preferably from 6 to 80 μm, even more preferably from 8 to 60 μm, and most preferably from 10 to 40 μm.

According to one embodiment the first hydromagnesite and the second hydromagnesite are independently selected from the group consisting of ground natural hydromagnesite, precipitated hydromagnesite, surface-treated hydromagnesite, and mixtures thereof, preferably precipitated hydromagnesite. According to another embodiment the at least one active agent is adsorbed onto and/or adsorbed and/or absorbed into the second hydromagnesite.

According to one embodiment the at least one active agent is an agrochemical active agent or a precursor thereof, preferably selected from fungicides, herbicides, insecticides, miticides, acaricides, nematicides, bactericides, rodenticides, molluscicides, avicides, repellents, attractants, biocontrol agents, soil additives, fertilizers, micronutrients, phytohormones, biostimulants, or mixtures thereof, and most preferably the at least one active agent is selected from pyrimethanil, 2,4-D, etofenprox, and mixtures thereof. According to another embodiment the second hydromagnesite is loaded with at least 1 wt.-% of at least one active agent, based on the total weight of the second hydromagnesite, preferably at least 10 wt.-%, more preferably at least 20 wt.-%, even more preferably at least 30 wt.-%, still more preferably at least 40 wt.-%, and most preferably at least 50 wt.-%.

According to one embodiment the first hydromagnesite is present in an amount from 1 wt.-% to 99 wt.-%, preferably from 1 wt.-% to 70 wt.-%, more preferably from 5 wt.-% to 50 wt.-%, even more preferably from 5 wt.-% to 40 wt.-%, and most preferably from 10 wt.-% to 30 wt.-%, based on the total weight of the delivery system, and the second hydromagnesite is present in an amount from 1 wt.-% to 99 wt.-%, preferably from 30 wt.-% to 99 wt.-%, more preferably from 50 wt.-% to 95 wt.-%, even more preferably from 60 wt.-% to 95 wt.-%, and most preferably from 70 wt.-% to 90 wt.-%, based on the total weight of the delivery system. According to another embodiment the delivery system further comprises a disintegration agent, preferably the disintegration agent is selected from the group consisting of modified cellulose gum, insoluble cross-linked polyvinylpyrrolidone, starch glycolate, micro crystalline cellulose, pregelatinized starch, sodium carboxymethyl starch, low-substituted hydroxypropyl cellulose, homopolymer of N-vinyl-2-pyrrolidone, alkyl-, hydroxyalkyl-, carboxyalkyl-cellulose ester, alginate, microcrystalline cellulose, ion exchange resin, chitin, chitosan, clay, gellan gum, crosslinked polacrillin copolymers, agar, gelatin, dextrin, acrylic acid polymer, cross-linked carboxymethylcellulose, carboxymethylcellulose salt, hydroxpropyl methyl cellulose phthalate, shellac, starch, and mixtures thereof, preferably carboxymethylcellulose salt, and more preferably croscarmellose salt. According to still another embodiment the delivery system is in the form of a powder, a tablet, a pellet, a bar, or granules, preferably a tablet, and more preferably an effervescent tablet or fast disintegrating tablet.

According to one embodiment the second hydromagnesite is prepared by the following steps: i) providing unloaded hydromagnesite, ii) providing at least one active agent, and iii) contacting the unloaded hydromagnesite of step i) with the at least one active agent of step ii) to form a hydromagnesite that is loaded with at least one active agent.

It should be understood that for the purpose of the present invention, the following terms have the following meaning:

The term “surface-treated” in the meaning of the present invention refers to a material which has been contacted with at least one surface-treatment composition comprising at least one surface treatment agent such as to obtain at least one surface-treatment layer on at least a part of the surface of the material.

Where in this application it is described that a particle (e.g., the hydromagnesite) is “loaded with” at least one active agent, this means that said at least one active agent may be generally present on all sites of the particle which are directly accessible from the outside of said particle. These sites include the outer surface of a particle as well as pores or cavities being accessible from the outer surface.

The “particle size” of particulate materials, other than hydromagnesite, herein is described by its weight-based distribution of particle sizes dₓ. Therein, the value dₓ represents the diameter relative to which x % by weight of the particles have diameters less than dₓ. This means that, for example, the d₂₀ value is the particle size at which 20 wt.-% of all particles are smaller than that particle size. The d₅₀ value is thus the weight median particle size, i.e. 50 wt.-% of all particles are smaller than this particle size. For the purpose of the present invention, the particle size is specified as weight median particle size d₅₀ (wt) unless indicated otherwise. Particle sizes were determined by using a Sedigraph™ 5100 instrument or Sedigraph™ 5120 instrument of Micromeritics Instrument Corporation. The method and the instrument are known to the skilled person and are commonly used to determine the particle size of fillers and pigments. The measurements were carried out in an aqueous solution of 0.1 wt.-% Na₄P₂O₇.

The “particle size” of hydromagnesite herein is described as volume-based particle size distribution. Volume-based median particle size d₅₀ was evaluated using a Malvern Mastersizer 2000 or 3000 Laser Diffraction System. The d₅₀ or d₉₈ value, measured using a Malvern Mastersizer 2000 or 3000 Laser Diffraction System, indicates a diameter value such that 50% or 98% by volume, respectively, of the particles have a diameter of less than this value. The raw data obtained by the measurement are analysed using the Mie theory, with a particle refractive index of 1.57 and an absorption index of 0.005.

A “salt” in the meaning of the present invention is a chemical compound consisting of an assembly of cations and anions (cf. IUPAC, Compendium of Chemical Terminology, 2nd Ed. (the “gold book”), 1997, “salt”).

The “specific surface area” (expressed in m²/g) of a material as used throughout the present document can be determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 100° C. or 120° C. under vacuum for a period of 30 min or 60 min prior to measurement. The total surface area (in m²) of said material can be obtained by multiplication of the specific surface area (in m²/g) and the mass (in g) of the material.

For the purpose of the present invention, the “solids content” of a liquid composition is a measure of the amount of material remaining after all the solvent or water has been evaporated. If necessary, the “solids content” of a suspension given in wt. % in the meaning of the present invention can be determined using a Moisture Analyzer HR73 from Mettler-Toledo (T=120° C., automatic switch off 3, standard drying) with a sample size of 5 to 20 g.

A “suspension” or “slurry” in the meaning of the present invention comprises undissolved solids and water, and optionally further additives, and usually contains large amounts of solids and, thus, is more viscous and can be of higher density than the liquid from which it is formed.

The term “aqueous” suspension refers to a system, wherein the liquid phase comprises, preferably consists of, water. However, said term does not exclude that the liquid phase of the aqueous suspension comprises minor amounts of at least one water-miscible organic solvent selected from the group comprising methanol, ethanol, acetone, acetonitrile, tetrahydrofuran and mixtures thereof. If the aqueous suspension comprises at least one water-miscible organic solvent, the liquid phase of the aqueous suspension comprises the at least one water-miscible organic solvent in an amount of from 0.1 to 40.0 wt.-% preferably from 0.1 to 30.0 wt.-%, more preferably from 0.1 to 20.0 wt.-% and most preferably from 0.1 to 10.0 wt.-%, based on the total weight of the liquid phase of the aqueous suspension. For example, the liquid phase of the aqueous suspension consists of water.

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

According to the present invention a delivery system comprising a first hydromagnesite and a second hydromagnesite is provided. The first hydromagnesite is an unloaded hydromagnesite and the second hydromagnesite is loaded with at least one active agent.

In the following details and preferred embodiments of the inventive composition will be set out in more details. It is to be understood that these technical details and embodiments also apply to the inventive method.

### Hydromagnesite

The delivery system of the present invention comprises a first hydromagnesite and a second hydromagnesite.

Hydromagnesite or basic magnesium carbonate, which is the standard industrial name for hydromagnesite, is a naturally occurring mineral which is found in magnesium rich minerals such as serpentine and altered magnesium rich igneous rocks, but also as an alteration product of brucite in periclase marbles. Hydromagnesite is described as having the following formula Mg₅(CO₃)₄(OH)₂·4H₂O.

It should be appreciated that hydromagnesite is a very specific mineral form of magnesium carbonate and occurs naturally as small needle-like crystals or crusts of acicular or bladed crystals. In addition thereto, it should be noted that hydromagnesite is a distinct and unique form of magnesium carbonate and is chemically, physically and structurally different from other forms of magnesium carbonate. Hydromagnesite can readily be distinguished from other magnesium carbonates by x-ray diffraction analysis, thermogravimetric analysis or elemental analysis. Unless specifically described as hydromagnesite, all other forms of magnesium carbonates (e.g. artinite (Mg₂(CO₃)(OH)₂·3 H₂O), dypingite (Mg₅(CO₃)₄(OH)₂·5H₂O), giorgiosite (Mg₅(CO₃)₄(OH)₂·5 H₂O), pokrovskite (Mg₂(CO₃)(OH)₂·0.5H₂O), magnesite (MgCO₃), barringtonite (MgCO₃·2 H₂O), lansfordite (MgCO₃·5H₂O) and nesquehonite (MgCO₃·3H₂O)) are not hydromagnesite within the meaning of the present invention and do not correspond chemically to the formula described above.

Besides the natural hydromagnesite, precipitated hydromagnesite (or synthetic magnesium carbonate) can be prepared. For instance, U.S. Pat. Nos. 1,361,324, 935,418, GB548197 and GB544907 generally describe the formation of aqueous solutions of magnesium bicarbonate (typically described as “Mg(HCO₃)₂”), which is then transformed by the action of a base, e.g., magnesium hydroxide, to form hydromagnesite. Other processes described in the art suggest to prepare compositions containing both, hydromagnesite and magnesium hydroxide, wherein magnesium hydroxide is mixed with water to form a suspension which is further contacted with carbon dioxide and an aqueous basic solution to form the corresponding mixture; cf. for example U.S. Pat. No. 5,979,461.

It is appreciated that the hydromagnesite can be one type or a mixture of different types of hydromagnesite. In one embodiment of the present invention, the first hydromagnesite comprises, preferably consists of, one type of hydromagnesite and/or the second hydromagnesite comprises, preferably consists of, one type of hydromagnesite. Alternatively, the first hydromagnesite comprises, preferably consists of, two or more types of hydromagnesites and/or the second hydromagnesite comprises, preferably consists of, two or more types of hydromagnesites.

According to one embodiment, the first hydromagnesite and the second hydromagnesite are independently selected from the group consisting of ground natural hydromagnesite, precipitated hydromagnesite, surface-treated hydromagnesite, and mixtures thereof, preferably precipitated hydromagnesite.

According to one embodiment, the first hydromagnesite is identical to the second hydromagnesite and the first hydromagnesite and the second magnesite are selected from the group consisting of ground natural hydromagnesite, precipitated hydromagnesite, surface-treated hydromagnesite, and mixtures thereof, preferably precipitated hydromagnesite.

The first hydromagnesite and/or second hydromagnesite may be surface-treated with a surface treatment agent or may be a blend of surface-treated hydromagnesite and non-surface treated hydromagnesite. The surface treatment may further improve the surface characteristics and especially may increase the hydrophobicity of the hydromagnesite, which may further improve the compatibility of the hydromagnesite with the at least one active agent or further components of the inventive composition.

According to one embodiment, the surface-treated hydromagnesite is obtained by treating the surface of the hydromagnesite with one or more compound(s) selected from the group consisting of phosphoric acid, a polyphosphate, a carboxylic acid containing up to six carbon atoms, a di-, and tri-carboxylic acid containing up to six carbon atoms where the carboxylic acid groups are linked by a chain of 0-4 intermittent carbon atoms, a water-insoluble polymer, a water-insoluble wax, a silicate-, and/or aluminate-group containing compound, and a corresponding salt thereof. Surface-treated hydromagnesite may obtained by treating the surface of the hydromagnesite with one compound. Alternatively, the surface-treated hydromagnesite is obtained by treating the surface of the hydromagnesite with two or more compounds. For example, the surface-treated hydromagnesite may be obtained by treating the surface of the hydromagnesite with two or three or four compounds, like two compounds.

According to one embodiment, the surface-treated hydromagnesite is obtained by treating the surface of the magnesium ion-containing material with phosphoric acid. In another embodiment, the surface-treated hydromagnesite is obtained by treating the surface of the hydromagnesite with a salt of phosphoric acid, e.g. an alkali metal salt of phosphoric acid. For example, the alkali metal salt of phosphoric acid is sodium phosphate or potassium phosphate, preferably sodium phosphate.

Additionally or alternatively, the surface-treated hydromagnesite may be obtained by treating the surface of the hydromagnesite with a polyphosphate. It is to be noted that a “polyphosphate” in the meaning of the present invention refers to the condensation products of the salts of ortho-phosphoric acid. The polyphosphate is typically of the formula M₍ₙ₊₂₎PnO₍₃ₙ₊₁₎, wherein n is an integer of ≥2, preferably in the range from 2 to 30, more preferably from 4 to 20, most preferably from 10 to 15; and M is selected from a proton, an alkali metal ion and mixtures thereof, preferably H⁺, Na⁺ and/or K⁺, more preferably H⁺ and/or Na⁺. Thus, the polyphosphate is preferably a linear or branched polyphosphate. The polyphosphate is preferably selected from diphosphates, triphosphates, tetraphosphates and higher phosphate polymers. The polyphosphate is in the form of a salt and preferably comprises an alkali metal ion, more preferably sodium or potassium ions. Additionally or alternatively, the polyphosphate is a hydrate salt of the polyphosphate.

Additionally or alternatively, the polyphosphate is a cyclic polyphosphate (also called polymeric metaphosphate) of the general formula MₙPₙO₃ₙ, wherein n is an integer of ≥2, preferably in the range from 2 to 20, more preferably from 2 to 10, even more preferably from 2 to 8, most preferably n is 3, 4 or 6, e.g. n is 6; and M is selected from a proton, an alkali metal ion and mixtures thereof, preferably H⁺, Na⁺ and/or K⁺, more preferably H⁺ and/or Na⁺.

Thus, the polyphosphate is preferably mono sodium diphosphate (anhydrous) (NaH₃P₂O₇), disodium diphosphate (anhydrous) (Na₂H₂P₂O₇), disodium diphosphate (hexahydrate) (Na₂H₂P₂O₇(H₂O)₆), trisodium diphosphate (anhydrous) (Na₃HP₂O₇), trisodium diphosphate (monohydrate) (Na₃HP₂O₇(H₂O)), trisodium diphosphate (nonahydrate) (Na₃HP₂O₇(H₂O)₉), tetrasodium diphosphate (anhydrous) (Na₄P₂O₇), tetrasodium diphosphate (decahydrate) (Na₄P₂O₇(H₂O)₁₀), or sodium polyphosphate, wherein n in the formula M₍ₙ₊₂₎PₙO₍₃ₙ₊₁₎ is from 4 to 20 and preferably from 10 to 15.

Additionally or alternatively, the surface-treated hydromagnesite may be obtained by treating the surface of the hydromagnesite with a carboxylic acid containing up to six carbon atoms. The carboxylic acid containing up to six carbon atoms is preferably an aliphatic carboxylic acid and may be selected from one or more linear chain, branched chain, saturated, unsaturated and/or alicyclic carboxylic acids. Preferably, the carboxylic acid containing up to six carbon atoms is a monocarboxylic acid, i.e. the carboxylic acid containing up to six carbon atoms is characterized in that a single carboxyl group is present. Said carboxyl group is placed at the end of the carbon skeleton. According to one embodiment the carboxylic acid containing up to six carbon atoms is preferably selected from the group consisting of carbonic acid, formic acid, acetic acid, propanoic acid, butanoic acid, pentanoic acid, hexanoic acid and mixtures thereof. More preferably, the carboxylic acid containing up to six carbon atoms is selected from the group consisting of propanoic acid, butanoic acid, pentanoic acid, hexanoic acid and mixtures thereof. According to another embodiment, the surface-treated hydromagnesite is obtained by treating the surface of the hydromagnesite with a salt of the carboxylic acid containing up to six carbon atoms, e.g. an alkali metal salt of the carboxylic acid containing up to six carbon atoms. For example, the alkali metal salt of the carboxylic acid containing up to six carbon atoms is sodium pentanoate or potassium pentanoate, preferably sodium pentanoate.

Additionally or alternatively, the surface-treated hydromagnesite is obtained by treating the surface of the hydromagnesite with a di- and/or tri-carboxylic acid containing up to six carbon atoms where the carboxylic acid groups are linked by a chain of 0-4 intermittent carbon atoms. The dicarboxylic acid containing up to six carbon atoms is characterized in that two carboxyl groups are present. Said carboxyl groups are preferably placed at each end of the carbon skeleton with the proviso that the carboxylic acid groups are linked by a chain of 0-4 intermittent carbon atoms. According to one embodiment, the dicarboxylic acid containing up to six carbon atoms is preferably selected from the group consisting of oxalic acid, malonic acid, succinic acid, glutaric acid, adipic acid, tartaric acid, fumaric acid and mixtures thereof. More preferably, the dicarboxylic acid containing up to six carbon atoms is selected from the group consisting of oxalic acid, malonic acid, tartaric acid, fumaric acid and mixtures thereof. According to another embodiment, the surface-treated hydromagnesite is obtained by treating the surface of the hydromagnesite with a salt of the dicarboxylic acid containing up to six carbon atoms, e.g. an alkali metal salt of the dicarboxylic acid containing up to six carbon atoms. For example, the alkali metal salt of the dicarboxylic acid containing up to six carbon atoms is sodium oxalate, sodium tartrate, potassium oxalate or potassium tartrate, preferably sodium oxalate or sodium tartrate, more preferably sodium oxalate. It is appreciated that the salt of the dicarboxylic acid containing up to six carbon atoms can be a monobasic or dibasic salt of the dicarboxylic acid. For example, the salt of the dicarboxylic acid containing up to six carbon atoms can be a monobasic or dibasic oxalate, such as monobasic or dibasic sodium oxalate. In one embodiment, the tricarboxylic acid containing up to six carbon atoms is preferably selected from the group consisting of citric acid, isocitric acid, aconitic acid and mixtures thereof. More preferably, the tricarboxylic acid containing up to six carbon atoms is selected from citric acid and/or isocitric acid. In one embodiment, the surface-treated hydromagnesite is obtained by treating the surface of the hydromagnesite with a salt of the tricarboxylic acid containing up to six carbon atoms, e.g. an alkali metal salt of the tricarboxylic acid containing up to six carbon atoms. For example, the alkali metal salt of the tricarboxylic acid containing up to six carbon atoms is sodium citrate or potassium citrate, preferably sodium citrate. It is appreciated that the salt of the tricarboxylic acid containing up to six carbon atoms can be a monobasic or dibasic or tribasic salt of the tricarboxylic acid. For example, the salt of the tricarboxylic acid containing up to six carbon atoms can be a monobasic or dibasic or tribasic citrate, such as monobasic or dibasic or tribasic sodium citrate.

Additionally or alternatively, the surface-treated hydromagnesite is obtained by treating the surface of the hydromagnesite with a water-insoluble polymer. Preferably, the water-insoluble polymer may be selected from polyvinyl ether, polypropylene glycol, carboxymethyl cellulose and mixtures thereof. Such polymers are well known in the art. In one embodiment, the water-insoluble polymer has a melting temperature Tm between 25-150° C. The water-insoluble polymer preferably has a solubility in water at 23° C. (±2° C.) of less than or equal to 10 mg/L. According to one embodiment, the surface-treated hydromagnesite is obtained by treating the surface of the magnesium ion-containing material with a salt of the water-insoluble polymer, e.g. an alkali metal salt of the water-insoluble polymer. For example, the alkali metal salt of the water-insoluble polymer atoms is sodium carboxymethyl cellulose or potassium carboxymethyl cellulose, preferably sodium carboxymethyl cellulose.

Additionally or alternatively, the surface-treated hydromagnesite may be obtained by treating the surface of the hydromagnesite with a water-insoluble wax. Preferably, the water-insoluble wax may be paraffin wax or lanolin. It is appreciated that paraffin wax consists of a mixture of hydrocarbon molecules containing between twenty and forty carbon atoms. Lanolin is typically composed predominantly of long-chain waxy esters and the remainder being lanolin alcohols, lanolin acids and lanolin hydrocarbons. Such waxes are well known in the art. According to one embodiment, the water-insoluble wax has a melting temperature Tm between 25-150° C. The water-insoluble wax may preferably have a solubility in water at 23° C. (±2° C.) of less than or equal to 10 mg/L. In one embodiment, the surface-treated hydromagnesite is obtained by treating the surface of the hydromagnesite with a salt of the water-insoluble wax, e.g. an alkali metal salt of the water-insoluble wax preferably a sodium salt of the water-insoluble wax.

In one embodiment, the surface-treated hydromagnesite is obtained by treating the surface of the hydromagnesite with a silicate-, and/or aluminate-group containing compound. For example, the surface-treated hydromagnesite may be obtained by treating the surface of the hydromagnesite with a silicate- or aluminate-group containing compound. Alternatively, the surface-treated hydromagnesite may be obtained by treating the surface of the hydromagnesite with a silicate- and aluminate-group containing compound. It is appreciated that the silicate-, and/or aluminate-group containing compound is preferably a silicate- or aluminate-group containing compound. Preferably, the silicate-, and/or aluminate-group containing compound may be selected from the group comprising alkali metal silicates, alkali metal aluminates, silicon alkoxides and aluminium alkoxides. More preferably, the silicate-, and/or aluminate-group containing compound may be selected from the group comprising sodium silicate, potassium silicate, sodium aluminate, potassium aluminate, tetramethyl orthosilicate, tetraethyl orthosilicate, aluminium methoxide, aluminium ethoxide, aluminium isopropoxide, and mixtures thereof. Most preferably, the silicate-, and/or aluminate-group containing compound may be selected from the group comprising sodium silicate, tetraethyl orthosilicate, and aluminium isopropoxide. For example, the silicate-group containing compound is sodium silicate, preferably in the form of an aqueous solution which is also called “water glass” or “sodium water glass”.

Preferably, the surface-treated hydromagnesite may be obtained by treating the surface of the hydromagnesite with phosphoric acid or an alkali metal salt of phosphoric acid, such as sodium phosphate, more preferably an alkali metal salt of phosphoric acid, such as sodium phosphate. Alternatively, the surface-treated hydromagnesite may be obtained by treating the surface of the hydromagnesite with a polyphosphate, such as tetrasodium diphosphate (anhydrous) (Na4P2O7) or sodium polyphosphate. Alternatively, the surface-treated hydromagnesite may be obtained by treating the surface of the hydromagnesite with citric acid or an alkali metal salt of citric acid, such as sodium citrate, more preferably an alkali metal salt of citric acid, such as sodium citrate.

In view of the above, the surface of the hydromagnesite preferably comprises one or more compound(s) selected from the group consisting of phosphoric acid, a polyphosphate, a carboxylic acid containing up to six carbon atoms, a di-, and tri-carboxylic acid containing up to six carbon atoms where the carboxylic acid groups are linked by a chain of 0-4 intermittent carbon atoms, a water-insoluble polymer, a water-insoluble wax, and a corresponding salt thereof and/or reaction products thereof.

The term “reaction products” in the meaning of the present invention refers to products obtained by contacting the surface of the hydromagnesite with one or more compound(s) selected from the group consisting of phosphoric acid, a polyphosphate, a carboxylic acid containing up to six carbon atoms, a di-, and tri-carboxylic acid containing up to six carbon atoms where the carboxylic acid groups are linked by a chain of 0-4 intermittent carbon atoms, a water-insoluble polymer, a water-insoluble wax, a silicate- and/or aluminate-group containing compound, and a corresponding salt thereof. Said reaction products are formed between the applied one or more compound(s) and reactive molecules located at the surface of the hydromagnesite.

It is appreciated that the surface-treated hydromagnesite is preferably obtained by treating the surface of the hydromagnesite with the one or more compound(s) in an amount from 0.1 to 35 wt.-%, preferably from 1 to 25 wt.-%, based on the total dry weight of the hydromagnesite. For example, the surface-treated hydromagnesite is preferably obtained by treating the surface of the hydromagnesite with the one or more compound(s) in an amount from 0.1 to 20 wt.-%, based on the total dry weight of the hydromagnesite. Preferably, the surface-treated hydromagnesite is obtained by treating the surface of the hydromagnesite with the one or more compound(s) in an amount from 0.3 to 10 wt.-%, based on the total dry weight of the hydromagnesite. Even more preferably, the surface-treated hydromagnesite is obtained by treating the surface of the hydromagnesite with the one or more compound(s) in an amount from 0.5 to 5 wt.-%, based on the total dry weight of the hydromagnesite.

In general, the surface-treated hydromagnesite can be prepared by any known method suitable for obtaining a treatment layer of one or more compound(s) on the surface of filler materials such hydromagnesite.

For example, the surface-treated hydromagnesite may be prepared in a dry method, e.g. by applying the one or more compound(s) onto the surface of the hydromagnesite without using solvents. If the one or more compound(s) are in a solid state, the one or more compound(s) may be heated in order to provide them in a liquid state for ensuring an essentially even distribution of the one or more compound(s) on the surface of the magnesium ion-containing material. Alternatively, the surface-treated hydromagnesite may be prepared in a wet method, e.g. by dissolving the one or more compound(s) in a solvent and applying the mixture onto the surface of the hydromagnesite. Optionally the mixture comprising the solvent and the one or more compound(s) may be heated. If the one or more compound(s) are dissolved in a solvent, the solvent is preferably water or an organic solvent, preferably selected from methanol, acetone, isopropyl alcohol, 1,3-butylene glycol, ethyl acetate, glycerol, hexane, methylene chloride and ethanol.

In general, the step of applying the one or more compound(s) on the surface of the hydromagnesite may be carried out by any method suitable for achieving an essentially even distribution of the one or more compound(s) on the surface of the hydromagnesite. Thus, the one or more compound(s) and the hydromagnesite should be agitated or shaken to facilitate and accelerate the preparation of the surface-treated hydromagnesite, e.g. by using a mixing device, spray coater or encapsulation processes. If a solvent is use, the obtained surface-treated hydromagnesite may be dried to remove the volatile components, preferably under vacuum.

In the dry and wet method, the step of applying the one or more compound(s) on the surface of the hydromagnesite may be carried out in a single step or in at least two steps.

According to one embodiment of the present invention, the surface-treated hydromagnesite is thus prepared by means of one or more of the following methods:
(i) dry treatment, i.e. treating the surface of the hydromagnesite with the one or more compound(s) which is/are in neat form, preferably in a mixing device or by using a spray coater;
(ii) wet treatment, i.e. treating the surface of the hydromagnesite with the one or more compound(s) which is/are dissolved in a solvent, optionally under heating, preferably in a mixing device or by using a spray coater; or
(iii) melt dry treatment, i.e. treating the surface of the hydromagnesite with a melt of the one or more compound(s) which is/are in neat form in a heated mixer (e.g. a fluid bed mixer).

According to one embodiment, the first hydromagnesite and/or the second hydromagnesite are non-surface treated hydromagnesite. In other words, the first hydromagnesite and/or the second hydromagnesite may be ground natural hydromagnesite, precipitated hydromagnesite, or mixtures thereof, and preferably precipitated hydromagnesite.

The first hydromagnesite and the second hydromagnesite are present in form of a particulate material.

According to one embodiment the first hydromagnesite has a specific surface area in the range from 25 to 150 m²/g, preferably from 35 to 120 m²/g, and most preferably from 35 to 100 m²/g, and/or the second hydromagnesite has a specific surface area in the range from 25 to 150 m²/g, preferably from 35 to 120 m²/g, and most preferably from 35 to 100 m²/g, measured using nitrogen and the BET method according to ISO 9277:2010. It will be understood by the skilled person that specific surface area values always refer to the specific surface area of unloaded hydromagnesite, i.e. in case of the second hydromagnesite to the specific surface area before it has been loaded with the at least one active agent.

According to one embodiment the first hydromagnesite has a volume determined median particle size d₅₀ from 1 to 75 μm, preferably from 1.2 to 50 μm, more preferably from 1.5 to 30 μm, even more preferably from 1.7 to 15 μm, and most preferably from 1.9 to 10 μm, and/or the second hydromagnesite has a volume determined median particle size d₅₀ from 1 to 75 μm, preferably from 1.2 to 50 μm, more preferably from 1.5 to 30 μm, even more preferably from 1.7 to 15 μm, and most preferably from 1.9 to 10 μm. In addition or alternatively, the first hydromagnesite has a volume determined top cut particle size d₉₈ from 2 to 150 μm, preferably from 4 to 100 μm, more preferably from 6 to 80 μm, even more preferably from 8 to 60 μm, and most preferably from 10 to 40 μm, and/or the second hydromagnesite has a volume determined top cut particle size d₉₈ from 2 to 150 μm, preferably from 4 to 100 μm, more preferably from 6 to 80 μm, even more preferably from 8 to 60 μm, and most preferably from 10 to 40 μm. It will be understood by the skilled person that the volume determined median particle size d₅₀ and volume determined top cut particle size d₉₈ values always refer to the particle size of unloaded hydromagnesite, i.e. in case of the second hydromagnesite to the volume determined median particle size d₅₀ and volume determined top cut particle size des before it has been loaded with the at least one active agent.

The specific pore volume is measured using a mercury intrusion porosimetry measurement using a Micromeritics Autopore V 9620 mercury porosimeter having a maximum applied pressure of mercury 414 MPa (60 000 psi), equivalent to a Laplace throat diameter of 0.004 μm (˜ nm). The equilibration time used at each pressure step is 20 seconds. The sample material is sealed in a 5 cm3 chamber powder penetrometer for analysis. The data are corrected for mercury compression, penetrometer expansion and sample material compression using the software Pore-Comp (Gane, P. A. C., Kettle, J. P., Matthews, G. P. and Ridgway, C. J., “Void Space Structure of Compressible Polymer Spheres and Consolidated Calcium Carbonate Paper-Coating Formulations”, Industrial and Engineering Chemistry Research, 35(5), 1996, p 1753-1764).

The total pore volume seen in the cumulative intrusion data can be separated into two regions with the intrusion data from 214 μm down to about 1-4 μm showing the coarse packing of the sample between any agglomerate structures contributing strongly. Below these diameters lies the fine interparticle packing of the particles themselves. If they also have intraparticle pores, then this region appears bi modal, and by taking the specific pore volume intruded by mercury into pores finer than the modal turning point, i.e. finer than the bi-modal point of inflection, the specific intraparticle pore volume is defined. The sum of these three regions gives the total overall pore volume of the powder, but depends strongly on the original sample compaction/settling of the powder at the coarse pore end of the distribution.

By taking the first derivative of the cumulative intrusion curve the pore size distributions based on equivalent Laplace diameter, inevitably including pore-shielding, are revealed. The differential curves clearly show the coarse agglomerate pore structure region, the interparticle pore region and the intraparticle pore region, if present. Knowing the intraparticle pore diameter range it is possible to subtract the remainder interparticle and interagglomerate pore volume from the total pore volume to deliver the desired pore volume of the internal pores alone in terms of the pore volume per unit mass (specific pore volume). The same principle of subtraction, of course, applies for isolating any of the other pore size regions of interest.

According to one embodiment the first hydromagnesite and/or the second hydromagnesite has an intra-particle intruded specific pore volume in the range from 0.9 to 2.3 cm³/g, preferably from 1 to 2.1 cm³/g, and most preferably from 1.2 to 2.0 cm³/g, calculated from mercury porosimetry measurement. It will be understood by the skilled person that the intra-particle intruded specific pore volume always refer to the pore volume of unloaded hydromagnesite, i.e. in case of the second hydromagnesite to the intra-particle intruded specific pore volume before it has been loaded with the at least one active agent.

The intra-particle pore size of the first hydromagnesite preferably is in a range of from 0.004 to 1.6 μm, more preferably in a range of from 0.005 to 1.3 μm, especially preferably from 0.006 to 1.15 μm and most preferably of 0.007 to 1.0 μm, e.g. 0.1 to 0.67 μm and/or the intra-particle pore size of the second hydromagnesite preferably is in a range of from 0.004 to 1.6 μm, more preferably in a range of from 0.005 to 1.3 μm, especially preferably from 0.006 to 1.15 μm and most preferably of 0.007 to 1.0 μm, e.g. 0.1 to 0.67 μm, determined by mercury porosimetry measurement. It will be understood by the skilled person that the intra-particle pore size always refer to the pore size of unloaded hydromagnesite, i.e. in case of the second hydromagnesite to the intra-particle pore size before it has been loaded with the at least one active agent.

The first hydromagnesite and the second hydromagnesite may be provided in any suitable dry form. For example, the first hydromagnesite and/or the second hydromagnesite may be in form of a powder and/or in pressed or granulated form. The moisture content of the first hydromagnesite and/or the second hydromagnesite may be between 0.01 and 10 wt.-%, based on the total weight of the hydromagnesite. According to one embodiment, the moisture content of the first hydromagnesite is less than or equal to 8 wt.-%, based on the total weight of the first hydromagnesite, preferably less than or equal to 6 wt.-%, and more preferably less than or equal to 4 wt.-%, and/or the moisture content of the second hydromagnesite is less than or equal to 8 wt.-%, based on the total weight of the second hydromagnesite, preferably less than or equal to 6 wt.-%, and more preferably less than or equal to 4 wt.-%. According to another embodiment, the moisture content of the first hydromagnesite is between 0.01 and 8 wt.-%, preferably between 0.02 and 6 wt.-%, and more preferably between 0.03 and 4 wt. %, based on the total weight of the first hydromagnesite, and/or the moisture content of the second hydromagnesite is between 0.01 and 8 wt.-%, preferably between 0.02 and 6 wt.-%, and more preferably between 0.03 and 4 wt. %, based on the total weight of the second hydromagnesite.

According to one embodiment, the second hydromagnesite has a specific surface area in the range from 25 to 150 m²/g, preferably from 35 to 120 m²/g, and most preferably from 35 to 100 m²/g, measured using nitrogen and the BET method according to ISO 9277:2010 and before it has been loaded with the at least one active agent.

In addition or alternatively, the second hydromagnesite has an intra-particle intruded specific pore volume in the range from 0.9 to 2.3 cm³/g, preferably from 1 to 2.1 cm³/g, and most preferably from 1.2 to 2.0 cm³/g, calculated from mercury porosimetry measurement and measured before it has been loaded with the at least one active agent.

In addition or alternatively the second hydromagnesite has a volume determined median particle size d50 from 1 to 75 μm, preferably from 1.2 to 50 μm, more preferably from 1.5 to 30 μm, even more preferably from 1.7 to 15 μm, and most preferably from 1.9 to 10 μm, before it has been loaded with the at least one active agent, and/or
the second hydromagnesite has a volume determined top cut particle size d₉₈ from 2 to 150 μm, preferably from 4 to 100 μm, more preferably from 6 to 80 μm, even more preferably from 8 to 60 μm, and most preferably from 10 to 40 μm, before it has been loaded with the at least one active agent.

### Active Agents

According to the present invention, the second hydromagnesite is loaded with at least one active agent. The at least one active agent may be provided in neat form or in form of a formulated plant protection product.

The at least one active agent may be an agrochemical active agent or a precursor thereof. According to one embodiment the at least one active agent is selected from fungicides, herbicides, insecticides, miticides, acaricides, nematicides, bactericides, rodenticides, molluscicides, avicides, repellents, attractants, biocontrol agents, fertilizers, micronutrients, phytohormones, biostimulants, or mixtures thereof. The skilled person will appreciate that the at least one active agent may encompass any suitable chemical form, e.g. the at least one active agent may be provided in a protonated form, or a deprotonated form, e.g. in a neutralized form or in form of a salt.

Examples of suitable fungicides are acibenzolar-S-methyl, aldimorph, amisulbrom, anilazine, azaconazole, azoxystrobin, benalaxyl, benodanil, benomyl, benthiavalicarb, binapacryl, biphenyl, bitertanol, blasticidin-S, boscalid, bromuconazole, bupirimate, captafol, captan, carbendazim, carboxin, carpropamid, chloroneb, chlorothalonil, chlozolinate, copper, cyazofamid, cyflufenamid, cymoxanil, cyproconazole, cyprodinil, dichlofiuanid, diclocymet, diclomezine, dicloran, diethofencarb, difenoconazole, diflumetorim, dimethirimol, dimethomorph, dimoxystrobin, diniconazole, dinocap, dithianon, dodemorph, dodine, edifenphos, enestrobin, epoxiconazole, etaconazole, ethaboxam, ethirimol, etridiazole, famoxadone, fenamidone, fenarimol, fenbuconazole, fenfuram, fenhexamid, fenoxanil, fenpiclonil, fenpropidin, fenpropimorph, fentin acetate, fentin chloride, fentin hydroxide, ferbam, ferimzone, fluazinam, fludioxonil, fiumorph, fluopicolide, fluoxastrobin, fluquinconazole, fiusilazole, fiusulfamide, flutolanil, fiutriafol, folpet, fosetyl-AI, fthalide, fuberidazole, furalaxyl, furametpyr, guazatine, hexaconazole, hymexazole, imazalil, imibenconazole, iminoctadine, iodocarb, ipconazole, iprobenfos (IBP), iprodione, iprovalicarb, isoprothiolane, isotianil, kasugamycin, kresoxim-methyl, laminarin, mancozeb, mandipropamid, maneb, material of biological, mepanipyrim, mepronil, meptyldinocap, metalaxyl, metalaxyl-M, metconazole, methasulfocarb, metiram, metominostrobin, metrafenone, mineral oils, organic oils, myclobutanil, naftifine, nuarimol, octhilinone, ofurace, origin, orysastrobin, oxadixyl, oxolinic acid, oxpoconazole, oxycarboxin, oxytetracycline, pefurazoate, penconazole, pencycuron, penthiopyrad, phophorous acid and, picoxystrobin, piperalin, polyoxin, potassium bicarbonate, probenazole, prochloraz, procymidone, propamocarb, propiconazole, propineb, proquinazid, prothiocarb, prothioconazole, pyraclostrobin, pyrazophos, pyribencarb, pyributicarb, pyrifenox, pyrimethanil, pyroquilon, quinoxyfen, quintozene (PCNB), salts, silthiofam, simeconazole, spiroxamine, streptomycin, sulfur, tebuconazole, teclofthalam, tecnazene (TCNB), terbinafine, tetraconazole, thiabendazole, thifluzamide, thiophanate, thiophanate-methyl, thiram, tiadinil, tolclofosmethyl, tolylfiuanid, triadimefon, triadimenol, triazoxide, tricyclazole, tridemorph, trifloxystrobin, triflumizole, triforine, triticonazole, validamycin, valiphenal, vinclozolin, zineb, ziram, and zoxamide, 1-butyl-1-(2,4-dichlorophenyl)-2-(1,2,4-triazol-1-yl) ethanol (common name hexaconazole), 1-[(2-chlorophenyl)methyl]-1-(1,1-dimethylethyl)-2-(1,2,4-triazol-1-yl)ethanol, 1-(4-fluorophenyl)-1-(2-fluorophenyl)-2-(1,2,4-triazol-1-yl) ethanol (common name flutriafol), methyl (E)-2-[2-[6-(2-cyanophenoxy)pyrimidin-4-yloxy]phenyl]-3-methoxyacrylate, methyl (E)-2-[2-[6-(2-thioamidophenoxy)pyrimidin-4-yloxy]phenyl]-3-methoxyacrylate, methyl (E)-2-[2-[6-(2-fluorophenoxy)pyrimidin-4-yloxy]phenyl]-3-methoxyacrylate, methyl (E)-2-[2-[6-(2,6difluorophenoxy)pyrimidin-4-yloxy]phenyl]-3-methoxyacrylate, methyl (E)-2-[2-[3-(pyrimidin-2-yloxy)phenoxy]-phenyl]-3-methoxyacrylate, methyl (E)-2-[2-[3-(5-methylpyrimidin-2-yloxy)phenoxy]phenyl]-3-methoxyacrylate, methyl (E)-2-[2-[3-(phenyl-sulfonyloxy)phenoxy]phenyl]-3-methoxyacrylate, methyl (E)-2-[2-[3-[4-nitrophenoxy]-phenoxy]phenyl]-3-methoxyacrylate, methyl (E)-2-[2-phenoxyphenyl]-3-methoxyacrylate, methyl (E)-2-[2-(3,5-dimethylbenzoyl)pyrrol-1-yl]-3-methoxy-acrylate, methyl (E)-2-[2-(3-methoxyphenoxy)phenyl]-3-methoxyacrylate, methyl (E)-2-[2-(2-phenylethen-1-yl)phenyl]-3-methoxyacrylate, methyl (E)-2-(2-[3,5-dichloro-phenoxy]pyridin-3-yl)-3-methoxyacrylate, methyl (E)-2-(2-(3-(1,1,2,2-tetrafluoroethoxy)phenoxy)phenyl)-3-methoxyacrylate, methyl (E)-2-(2-[3-(alpha-hydroxybenzyl)phenoxy]phenyl)-3-methoxyacrylate, methyl (E)-2-(2-(4-phenoxypyridin-2-yloxy)phenyl)-3-methoxyacrylate, methyl (E)-2-[2-(3-n-propyloxyphenoxy)phenyl]-3-methoxyacrylate, methyl (E)-2-[2-(3-iso-propyloxyphenoxy)phenyl]-3-methoxyacrylate, methyl (E)-2-[2-[3-(2-fluorophenoxy)phenoxy]phenyl]-3-methoxy acrylate, methyl (E)-2-[2-(3-ethoxyphenoxy)phenyl]-3-methoxyacrylate, methyl (E)-2-[2-(4-tert-butylpyridin-2-yloxy)phenyl]-3-methoxyacrylate, methyl (E)-2-[2-[3-(3-cyanophenoxy)phenoxy]phenyl]-3-methoxyacrylate, methyl (E)-2-[2-(3-methylpyridin-2-yloxymethyl)phenyl]-3-methoxyacrylate, methyl (E)-2-[2-[6(2-methylphenoxy)pyrimidin-4-yloxy]phenyl]-3-methoxyacrylate, methyl (E)-2-[2-(5-bromopyridin-2-yloxymethyl)phenyl]-3-methoxyacrylate, methyl (E)-2-[2-(3-(3-iodopyridin-2-yloxy)phenoxy)phenyl]-3-methoxyacrylate, methyl (E)-2-[2-[6-(2-chloro-pyridin-3-yloxy)pyrimidin-4-yloxy]phenyl]-3-methoxyacrylate, (E),(E)-methyl 2-[2-(5,6-dimethylpyrazin-2-ylmethyloximinomethyl)phenyl]-3-methoxyacrylate, (E)-methyl 2-{2-[6-(6-methylpyridin-2-yloxy)pyrimidin-4-yloxy]phenyl}-3-methoxyacrylate, (E),(E)-methyl 2-{2-(3-methoxyphenyl)methyloximinomethyl]phenyl}-3-methoxyacrylate, (E)-methyl 2-{2-[6-(2-azidophenoxy)pyrimidin-4-yloxy]phenyl}-3-methoxyacrylate, (E),(E)-methyl 2-{2-[6-phenylpyrimidin-4-yl)methyloximinomethyl]phenyl}-3-methoxyacrylate, (E),(E)-methyl 2-{2-[(4-chlorophenyl)methyloximinomethyl]phenyl}-3-methoxyacrylate, (E)-methyl 2-{2-[6-(2-n-propylphenoxy)-1,3,5-triazin-4-yloxy]phenyl}-3-methoxyacrylate, (E),(E)-methyl 2-{2-[(3-nitrophenyl)methyloximinomethyl]phenyl}-3-methoxyacrylate, (RS)-4-(4-chlorophenyl)-2-phenyl-2-(1H-1,2,4-triazol-1-ylmethyl)butyronitrile, 1-[(2RS,4RS;2RS,4RS)-4-bromo-2-(2,4-dichlorophenyl)tetrahydrofurfuryl]-1H-1,2,4-triazole, 3-(2,4-dichlorophenyl)-2-(1H-1,2,4-triazol-1-yl)-quinazolin-4(3H)-one, (RS)-2,2-dimethyl-3-(2-chlorobenzyl)-4-(1H-1,2,4-triazol-1-yl)butan-3-ol, or mixtures and combinations thereof. According to a preferred embodiment, the fungicide is pyrimethanil.

Examples of suitable herbicides are acetochlor, acifiuorfen, aclonifen, alachlor, ametryn, amidosulfuron, aminopyralid, amitrole, anilofos, asulam, atrazine, azafenidin, azimsulfuron, benazolin, benfluralin, bensulfuron-methyl, bentazone, bifenox, binalafos, bispyribac-sodium, bromacil, bromoxynil, butachlor, butroxidim, cafenstrole, carbetamide, carfentrazone-ethyl, chloridazon, chlorimuron-ethyl, chlorobromuron, chlorotoluron, chlorsulfuron, cinidon-ethyl, cinosulfuron, clethodim, clomazone, clopyralid, cloransulam-methyl, clorsulfuron, cyanazine, cycloate, cyclosulfamuron, cycloxydim, dalapon, desmedipham, dicamba, dichlobenil, dichlormid, diclosulam, diflufenican, dimefuron, dimepipeate, dimethachlor, dimethenamid, diquat, diuron, esprocarb, ethalfluralin, ethametsulfuron-methyl, ethofumesate, ethoxysulfuron, fentrazamide, flazasulfuron, florasulam, fluchloralin, flufenacet, flumetsulam, flumioxazin, fluometuron, flupyrsulfuron-methyl, flurochloridone, fluroxypyr, flurtamone, fomesafen, foramsulfuron, glufosinate, hexazinone, imazamethabenz-m, imazamox, mazapic, imazapyr, imazaquin, imazethapyr, imazosulfuron, iodosulfuron, ioxynil, isoproturon, isoxaben, isoxaflutole, lactofen, lenacil, linuron, mefenacet, mesosulfuron-methyl, mesotrione, metamitron, metazachlor, methabenzthiazuron, metobromuron, metolachlor, metosulam, metoxuron, metribuzin, metsulfuron-methyl, molinate, msma, napropamide, nicosulfuron, norflurazon, oryzalin, oxadiargyl, oxadiazon, oxasulfuron, oxyfluorfen, paraquat, pendimethalin, phenmedipham, picloram, pretilachlor, profoxydim, prometryn, propanil, propisochlor, propoxycarbazone, propyzamide, prosulfocarb, prosulfuron, pyraflufen-ethyl, pyrazosulfuron, pyridate, pyrithiobac, quinclorac, quinmerac, rimsulfuron, sethoxydim, simazine, s-metolachlor, sulcotrione, sulfentrazone, sulfosulfuron, tebuthiuron, tepraloxydim, terbuthylazine, terbutryn, thifensulfuron-methyl, thiobencarb, tralkoxydim, tri-allate, triasulfuron, tribenuron-methyl, triclopyr, trifioxysulfuron, trifluralin, trifiusulfuron-methyl, tritosulfuron, or mixtures and combinations thereof. Preferred herbicides are acetochlor, atrazine, dicamba, glufosinate, paraquat, glyphosate, 2,4-D or mixtures and combinations thereof, preferably 2,4-D.

Examples of suitable insecticides are kerosene or borax, botanicals or natural organic compounds (e.g. allicin, anabasine, azadirachtin, carvacrol, d-limonene, matrine, nicotine, nornicotine, oxymatrine, pyrethrins, quassia, rhodojaponin-III, rotenone, ryania, sabadilla, sanguinarine, strychnine, or triptolide), chlorinated hydrocarbon (e.g. aldrin, bromo-DDT, camphechlor, chlordane, DDT, DFDT, ethyl-DDD, lindane, methoxychlor, or pentachlorophenol), organophosphates (e.g. bromfenvinfos, calvinphos, chlorfenvinphos, crotoxyphos, dichlorvos, dicrotophos, dimethylvinphos, fospirate, heptenophos, methocrotophos, mevinphos, propaphos, dioxabenzofos, fosmethilan, phenthoate, malathion, quinothion, diazinon, butonate, trichlorfon, mecarphon, crufomate, fenamiphos, fosthietan, mephosfolan, phosfolan, phosfolan-methyl, pirimetaphos, acephate, chloramine phosphorus, isocarbophos, isofenphos, isofenphos-methyl, methamidophos, phosglycin, or propetamphos), carbamates (e.g. bendiocarb, carbaryl, benfuracarb, carbofuran, carbosulfan, decarbofuran, furathiocarb, dimetan, dimetilan, hyquincarb, isolan, pirimicarb, pyramat, pyrolan, alanycarb, aldicarb, aldoxycarb, butocarboxim, butoxycarboxim, methomyl, nitrilacarb, oxamyl, tazimcarb, thiocarboxime, thiodicarb, thiofanox, allyxycarb, aminocarb, bufencarb, butacarb, carbanolate, cloethocarb, dicresyl, dimethacarb, dioxacarb, ethiofencarb, fenethacarb, fenobucarb, isoprocarb, methiocarb, metolcarb, mexacarbate, promacyl, promecarb, propoxur, or trimethacarb), fumigants (e.g. acrylonitrile, allyl isothiocyanate, carbon disulfide, carbon tetrachloride, p-dichlorobenzene, 1,2-dichloropropane, dimethyl disulfide, ethyl formate, ethylene dichloride, methylchloroform, methylene chloride, naphthalene, phosphine, sodium tetrathiocarbonate, sulfuryl fluoride, or tetrachloroethane) and benzene, synthetic pyrethroids (e.g. etofenprox, flufenprox, halfenprox, silafluofen), or mixtures and combinations thereof. According to a preferred embodiment, the insecticide is etofenprox.

Examples of suitable acaricides, preferably miticides, include permethrin, ivermectin, antibiotic miticides, carbamate miticides, dienochlor miticides, formamidine miticides, oxalic acid, organophosphate miticides, diatomaceous earth, dicofol, lime sulfur, abamectin, acequinocyl, bifenazate, bifenazate, chlorfenapyr, clofentezine, cyflumetofen, cypermethrin, dicofol, etoxazole, fenazaquin, fenpyroximate, hexythiazox, imidacloprid, propargite, pyridaben, spiromesifen, spirotetramat, or mixtures and combinations thereof.

Examples of suitable nematicides are avermectin nematicides, botanical nematicides, carbamate nematicides, fumigant nematicides, organophosphorus nematicides, cadusafos, ethoprophos, fenamiphos, phorate, fosthiazate, terbufos, triazophos, carbofuran, carbosulfan, thiodicarb, dazomet, metam sodium, abamectin, fluensulfone, carvacrol, cloethocarb, allyl isothiocyanate, imicyafos, furfural, or mixtures and combinations thereof.

Examples of suitable bactericides are amicarthiazol, bismerthiazol, bronopol, cellocidin, chloramphenicol, cresol, dichlorophen, dipyrithione, dodicin, ethylicin, fenaminosulf, fluopimomide, formaldehyde, hexachlorophene, hydrargaphen, 8-hydroxyquinoline sulfate, kasugamycin, ningnanmycin, nitrapyrin, octhilinone, oxolinic acid, oxytetracycline, phenazine oxide, probenazole, saijunmao, saisentong, streptomycin, tecloftalam, thiodiazole-copper, thiomersal, xinjunan, zinc thiazole, or mixtures and combinations thereof.

Examples of suitable rodenticides are botanical rodenticides, carbanilate rodenticides, coumarin rodenticides, indandione rodenticides, inorganic rodenticides, organochlorine rodenticides, organofluorine rodenticides, organophosphorus rodenticides, pyrimidinamine rodenticides, thiourea rodenticides, urea rodenticides, strychnine, warfarin, coumatetralyl, difenacoum, brodifacoum, flocoumafen, bromadiolone, diphacinone, chlorophacinone, pindone, sulfaquinoxaline, or mixtures and combinations thereof.

Examples of suitable molluscicides are allicin, bromoacetamide, calcium arsenate, cloethocarb, copper sulfate, fentin, niclosamide, Paris green, pentachlorophenol, sodium pentachlorophenate, tazimcarb, thiacloprid, thiodicarb, tralopyril, tributyltin oxide, trifenmorph trimethacarb, iron(III) phosphate, aluminium sulfate, ferric sodium EDTA, metaldehyde, methiocarb, acetylcholinesterase inhibitors, or mixtures and combinations thereof.

Examples of suitable avicides are 4-aminopyridine, endrin, fenthion, strychnine, DRC-1339 (3-chloro-4-methylaniline hydrochloride, Starlicide), CPTH (3-chloro-p-toluidine, the free base of Starlicide), Avitrol (4-aminopyridine), chloralose, or mixtures and combinations thereof.

Examples of suitable insect repellents are acrep, camphor, carboxide, dimethyl phthalate, methoquin-butyl, methylneodecanamide, 2-(octylthio)ethanol, oxamate, quwenzhi, quyingding, rebemide, zengxiaoan, dibutyl succinate, methyl anthranilate, benzaldehyde, DEET (N,N-diethyl-m-toluamide), dimethyl carbate, dimethyl phthalate, ethylhexanediol, icaridin, butopyronoxyl (trade name Indalone), ethyl butylacetylaminopropionate, metofluthrin, tricyclodecenyl allyl ether, birch tree bark, bog myrtle (Myrica gale), nepetalactone citronella oil, essential oil of the lemon eucalyptus (Corymbia citriodora), p-menthane-3,8-diol (PMD), neem oil, lemongrass, tea tree oil, or mixtures and combinations thereof.

Examples of suitable attractants are brevicomin, dominicalure, frontalin, grandlure, ipsdienol, ipsenol, japonilure, lineatin, megatomoic acid, α-multistriatin, oryctalure, sulcatol, trunc-call, ceralure, cue-lure, latilure, medlure, moguchun, muscalure, trimedlure, rescalure, disparlure, codlelure, gossyplure, hexalure, litlure, looplure, orfralure, ostramone, eugenol, methyl eugenol, siglure, or mixtures and combinations thereof.

Examples of suitable biocontrol agents are Trichoderma spp., Pseudomonas spp., Bacillus spp., Streptomyces spp., Clonostachys spp., pyrroles, dinitrophenols, sulfluramid, granuloviruses, nucleopolyhedroviruses, Beauveria bassiana strains, Metarhizium anisopliae strain F52, Paecilomyces fumosoroseus, Apopka strain 97, or mixtures and combinations thereof.

Suitable fertilizers may include inorganic and organic fertilizers and mixtures thereof. The fertilizers may also comprise micronutrients which include iron, zinc, manganese, magnesium, copper, calcium, boron, cobalt, iron (sulfur), sulfate, chlorine and molybdenum. A micronutrient herein is a nutrient whose natural level found in plants is 0.01 wt.-% or less. The sources of the micronutrients are, for example, oxides, hydroxides, salts, carbonates, chlorides, nitrates, sulfates, sequestrates, chelates and complexes. Typical oxides include FeO, Fe2O3, Fe3O₄, ZnO, ZnO2, CaO, CaO2, MnO, MnO2, Mn2O3, Mn2O7, Mn3O4, MgO, CuO, Cu2O, B2O3, MoO, MoO2, MoO3, Mo2O3, Mo2O5, CoO, and Co3O4.

Examples of suitable phytohormones are auxins, abscisics, brassinosteroids, jasmonates, traumatic acids, cytokinins, isoflavinoids, gibberelins, ethylene, salicylic acid, acetyl salicylic acid, indole acetic acid, gibberellic acid, gallic acid, cytokinin, abscisic acid, or mixtures and combinations thereof.

Examples of suitable biostimulants are humic substances such as humic acid and fulvic acid, seaweed extracts, amino acids, or mixtures and combinations thereof.

According to one embodiment, the at least one active agent is selected from pyrimethanil, 2,4-D, etofenprox, and mixtures thereof.

It is especially preferred that the at least one active agent has an absolute water solubility at 20° C. of less than 10 g/l, preferably less than 1.0 g/l, and most preferably less than 0.1 g/l. An improved efficacy is especially observed and especially advantageous for active agents having a poor water solubility as these compounds may have a tendency to be less effective in comparison to compounds being readily soluble in water.

### Loaded Hydromagnesite

According to the present invention the second hydromagnesite is loaded with the at least one active agent.

The loading is preferably an adsorption onto the surface of the second hydromagnesite, be it the outer or the inner surface of the hydromagnesite particle, i.e. the pore volume, or an absorption into the hydromagnesite particle, which is possible due to its porosity. In this respect, it is believed that because of the advantageous high specific surface area in combination with a high intra-particle intruded specific pore volume of hydromagnesite, this material is a superior carrier material to release previously loaded active agent(s) over time relative to common carrier materials having lower specific surface areas and/or intra-particle intruded specific pore volume.

According to one embodiment, the at least one active agent is adsorbed onto and/or adsorbed and/or absorbed into the second hydromagnesite. According to a further embodiment, the at least one active agent is loaded onto and/or into the pore volume of the hydromagnesite.

It will be appreciated by the skilled person that the amount of the at least one active agent loaded on the second hydromagnesite depends on the active agent(s) and the intended use.

According to one embodiment the second hydromagnesite is loaded with at least 1 wt.-% of at least one active agent, based on the total weight of the second hydromagnesite, preferably at least 10 wt.-%, more preferably at least 20 wt.-%, even more preferably at least 30 wt.-%, still more preferably at least 40 wt.-%, and most preferably at least 50 wt.-%. According to another embodiment the second hydromagnesite is loaded with at least one active agent in an amount from 1 to 80 wt.-%, based on the total weight of the second hydromagnesite, preferably from 5 to 60 wt.-%, more preferably from 10 to 50 wt.-%, even more preferably from 15 to 35 wt.-%, and most preferably from 20 to 30 wt.-%.

The second hydromagnesite may be prepared by the following steps:
i) providing unloaded hydromagnesite,
ii) providing at least one active agent, and
iii) contacting the unloaded hydromagnesite of step i) with the at least one active agent of step ii) to form a hydromagnesite that is loaded with at least one active agent.

The hydromagnesite may be provided in any suitable liquid or dry form in step i). For example, the hydromagnesite may be in form of a powder and/or a suspension. The suspension can be obtained by mixing the hydromagnesite with a solvent, preferably water. The hydromagnesite to be mixed with a solvent, and preferably water, may be provided in any form, for example, as suspension, slurry, dispersion, paste, powder, a moist filter cake or in pressed or granulated form.

In order to obtain a high loading of the at least one active agent on the hydromagnesite, it is advantageous to provide the hydromagnesite as concentrated as possible, i.e. the water content should be as low as possible. Thus, the hydromagnesite is preferably provided in dry from, e.g. as a powder, or in form of a highly concentrated suspension, e.g. having a solids content of more than 50 wt.-%, based on the total weight of the suspension.

In case the hydromagnesite is provided in dry form, the moisture content of the hydromagnesite can be between 0.01 and 20 wt.-%, based on the total weight of the hydromagnesite. The moisture content of the hydromagnesite can be, for example, in the range from 0.01 to 15 wt.-%, based on the total weight of the hydromagnesite, preferably in the range from 0.02 to 12 wt.-%, and more preferably in the range from 0.04 to 10 wt.-%.

According to step ii) of the present method, the at least one active agent is provided in the form of a liquid or dissolved in a solvent. That is to say, in one embodiment the at least one active agent is in the form of a liquid. The term “liquid” with regard to the at least one active agent refers to non-gaseous fluid active agent(s), which is/are readily flowable at the pressure conditions and temperature of use, i.e. the pressure and temperature at which the method, preferably method step iii), is carried out.

Thus, it is appreciated that the at least one active agent can be liquid in a temperature range from 5 to 200° C., preferably from 10 to 120° C. and most preferably from 10 to 100° C. For example, the at least one active agent can be liquid in a temperature range from 5 to 200° C., preferably from 10 to 120° C. and most preferably from 10 to 100° C. at ambient pressure conditions, i.e. at atmospheric pressure. Alternatively, the at least one active agent can be liquid in a temperature range from 5 to 200° C., preferably from 10 to 120° C. and most preferably from 10 to 100° C. at reduced pressure conditions, e.g. a pressure of from 100 to 700 mbar.

Alternatively, the at least one active agent may be dissolved in a solvent. That is to say, the at least one active agent and the solvent form a system in which no discrete solid particles are observed in the solvent, and thus, form a “solution”. In one embodiment of the present invention, the solvent is selected from the group comprising water, methanol, ethanol, n-butanol, isopropanol, n-propanol, acetone, dimethylsulphoxide, dimethylformamide, tetrahydrofurane, liquefied carbon dioxide, supercritical carbon dioxide, vegetable oils and the derivatives thereof, animal oils and the derivatives thereof, molten fats and waxes, and mixtures thereof. Preferably, the solvent may be selected from water, alkanes, esters, ethers, alcohols, such as ethanol, ethylene glycol and glycerol, liquefied carbon dioxide, supercritical carbon dioxide, and/or ketones, such as acetone. According to a preferred embodiment, the solvent is water or a mixture of water, alkanes, esters, ethers, alcohols and/or ketones.

The contacting of the hydromagnesite of step i) with the at least one active agent of step ii) may be carried out in any manner known by the skilled person. The contacting is preferably carried out under mixing. The mixing may be carried out under conventional mixing conditions. The skilled person will adapt these mixing conditions (such as the configuration of mixing pallets and mixing speed) according to his process equipment. It is appreciated that any mixing method which would be suitable to form the delivery system may be used.

It is appreciated that the hydromagnesite of step i) is loaded with at least one active agent of step ii) by contacting step iii) to form the second hydromagnesite that is loaded with at least one active agent. The loading may be achieved by adding the at least one active agent to the dry hydromagnesite.

According to the present invention, the hydromagnesite is defined to be loaded, if the specific surface area is at least partially covered and/or the intra-particle pore volume of same is at least partially filled by the at least one active agent, and if present, the solvent in which the at least one active agent is dissolved. For example, the second hydromagnesite is loaded, if the specific surface area is at least partially covered and/or the intra-particle pore volume of same is at least partially filled by at least 1 wt.-%, preferably at least 2 wt.-%, more preferably at least 4 wt.-%, and most preferably at least 5 wt.-%, based on the total weight of the second hydromagnesite, with the at least one active agent, and if present, the solvent in which the at least one active agent is dissolved.

Method step iii) may be carried out over a broad temperature and/or pressure range, provided that the at least one active agent is in liquid form. For example, method step iii) is carried out in a temperature range from 5 to 200° C., preferably from 10 to 120° C. and most preferably from 10 to 100° C. at ambient pressure conditions, i.e. at atmospheric pressure. Alternatively, method step iii) may be carried out in a temperature range from 5 to 200° C., preferably from 10 to 120° C. and most preferably from 10 to 100° C. at reduced pressure conditions, e.g. a pressure of from 100 to 700 mbar.

According to one embodiment, method step iii) is carried out at ambient temperature and pressure conditions, e.g., at room temperature, such as from about 5 to 35° C., preferably from 10 to 30° C. and most preferably from 15 to 25° C., and at atmospheric pressure. This embodiment preferably applies in case the at least one active agent is liquid at room temperature or are dissolved in a solvent.

In case the at least one active agent is dissolved in a solvent, the solvent may be preferably removed after method step iii), e.g. by evaporation. According to one embodiment, the method thus preferably comprises a further step of separating the prepared loaded second hydromagnesite from the excess solvent. The solvent may be preferably removed by means of separating the solvent from the loaded hydromagnesite. This may be preferably achieved by drying by means selected from the group comprising drying in a rotational oven, jet-drying, fluidized bed drying, freeze drying, flash drying, spray drying and temperature-controlled high or low shear mixer.

According to one embodiment the loaded, second hydromagnesite is prepared by the following steps:
i) providing unloaded hydromagnesite,
ii) providing at least one active agent dissolved in a solvent,
iii) contacting the unloaded hydromagnesite of step i) with the at least one active agent of step ii) to form a hydromagnesite that is loaded with the at least one active agent, and
iv) separating the loaded, second hydromagnesite formed in step iii) from the excess solvent.

The method for preparing the loaded, second hydromagnesite may comprise a further step v) of granulating the loaded, second hydromagnesite after step iii) or step iv), if present.

### Further Components

In addition to the first hydromagnesite being an unloaded hydromagnesite, and the second hydromagnesite being loaded with at least one active agent, the delivery system of the present invention may comprise further components.

According to one embodiment the delivery system further comprises a disintegration agent. Disintegration agents may promote disintegration of the delivery system and are well-known to the skilled person. According to one embodiment, the disintegration agent is selected from the group consisting of modified cellulose gum, insoluble cross-linked polyvinylpyrrolidone, starch glycolate, micro crystalline cellulose, pregelatinized starch, sodium carboxymethyl starch, low-substituted hydroxypropyl cellulose, homopolymer of N-vinyl-2-pyrrolidone, alkyl-, hydroxyalkyl-, carboxyalkyl-cellulose ester, alginate, microcrystalline cellulose, ion exchange resin, chitin, chitosan, clay, gellan gum, crosslinked polacrillin copolymers, agar, gelatin, dextrin, acrylic acid polymer, cross-linked carboxymethylcellulose, carboxymethylcellulose salt, hydroxpropyl methyl cellulose phthalate, shellac, starch, and mixtures thereof, preferably carboxymethylcellulose salt, and more preferably croscarmellose salt. However, any other disintegration agent known to the skilled person may also be used.

The disintegration agent may be present in an amount from 0.3 to 10 wt.-%, preferably from 0.5 to 8 wt.-%, more preferably from 1 wt.-% to 5 wt.-%, based on the total weight of the delivery system. According to a preferred embodiment, the disintegration agent is present in an amount from 3 to 4 wt.-%, based on the total weight of the delivery system.

According to a further embodiment, the delivery system comprises a formulating aid. The formulating aid may be present in an amount from 0.1 to 10 wt.-%, preferably from 0.3 to 5 wt.-%, more preferably from 0.5 to 2.5 wt.-%, based on the total weight of the delivery system.

According to one embodiment, the formulating aid is selected from polymers, fillers, binders, diluents, lubricants, film forming agents, adhesives, buffers, adsorbents, natural or synthetic scenting agents, natural or synthetic flavouring agents, natural or synthetic coloring agents, natural or synthetic sweeteners, natural or synthetic odour-masking agents, natural or synthetic flavouring- or taste-masking agents, and/or mixtures thereof.

Examples of suitable lubricants are long chain fatty acid esters or salts thereof such as palmitic and stearic acids, sorbitan esters of fatty acids, polyoxyethylated hydrogenated castor oil (e.g. the product sold under the trade name CREMOPHOR®), block copolymers of ethylene oxide and propylene oxide (e.g. products sold under trade names PLURONIC® and POLOXAMER), polyoxyethylene fatty alcohol ethers, polyoxyethylene sorbitan fatty acid esters, sorbitan esters of fatty acids, polyoxyethylene steraric acid esters, stearyl alcohol, glycerol dibehenate, sodium stearyl fumarate, glycerol distearate, lecithin, polyoxyethylene stearate, polyoxyethylene sorbitan fatty acid esters, fatty acid salts, mono and diacetyl tartaric acid esters of mono and diglycerides of edible fatty acids, citric acid esters of mono and diglycerides of edible fatty acids, saccharose esters of fatty acids, polyglycerol esters of fatty acids, polyglycerol esters of interesterified castor oil acid (E476), sodium stearoyllactylate, magnesium and/or calcium stearate, hydrogenated vegetable oils, stearic acid, sodium lauryl sulphate, magnesium lauryl sulphate, colloidal silica, talc, and combinations thereof.

Examples of suitable binders are water-soluble gums such as hydroxymethylcellulose, methylcellulose, or polyvinylpyrrolidone.

### Composition and Method for Preparing the Same

According to one aspect of the present invention, a delivery system is provided comprising a first hydromagnesite, wherein the first hydromagnesite is an unloaded hydromagnesite, and a second hydromagnesite, wherein the second hydromagnesite is loaded with at least one active agent. According to one embodiment, a delivery system is provided comprising a mixture of a first hydromagnesite and a second hydromagnesite, wherein the first hydromagnesite is an unloaded hydromagnesite and the second hydromagnesite is loaded with at least one active agent.

According to one embodiment the first hydromagnesite is present in an amount from 1 wt.-% to 99 wt.-%, preferably from 1 wt.-% to 70 wt.-%, more preferably from 5 wt.-% to 50 wt.-%, even more preferably from 5 wt.-% to 40 wt.-%, and most preferably from 10 wt.-% to 30 wt.-%, based on the total weight of the delivery system, and the second hydromagnesite is present in an amount from 1 wt.-% to 99 wt.-%, preferably from 30 wt.-% to 99 wt.-%, more preferably from 50 wt.-% to 95 wt.-%, even more preferably from 60 wt.-% to 95 wt.-%, and most preferably from 70 wt.-% to 90 wt.-%, based on the total weight of the delivery system.

According to another embodiment the first hydromagnesite is present in an amount from 1 wt.-% to 99 wt.-%, preferably from 1 wt.-% to 70 wt.-%, more preferably from 5 wt.-% to 50 wt.-%, even more preferably from 5 wt.-% to 40 wt.-%, and most preferably from 10 wt.-% to 30 wt.-%, based on the total weight of the first hydromagnesite and the second hydromagnesite, and the second hydromagnesite is present in an amount from 1 wt.-% to 99 wt.-%, preferably from 30 wt.-% to 99 wt. %, more preferably from 50 wt.-% to 95 wt.-%, even more preferably from 60 wt.-% to 95 wt.-%, and most preferably from 70 wt.-% to 90 wt.-%, based on the total weight of the first hydromagnesite and the second hydromagnesite.

According to one embodiment the at least one active agent is present in an amount of at least 0.1 wt.-%, preferably at least 0.3 wt.-%, more preferably at least 0.6 wt.-%, and most preferably at least 1 wt.-%, based on the total weight of the delivery system. According to another embodiment the at least one active agent is present in an amount of at least 0.1 wt.-%, preferably at least 0.3 wt.-%, more preferably at least 0.6 wt.-%, and most preferably at least 1 wt.-%, based on the total weight of the first hydromagnesite and the second hydromagnesite.

According to one embodiment, a delivery system is provided comprising a first hydromagnesite, wherein the first hydromagnesite is an unloaded hydromagnesite, and a second hydromagnesite, wherein the second hydromagnesite is loaded with at least one active agent, wherein
the first hydromagnesite is present in an amount from 1 wt.-% to 99 wt.-%, preferably from 1 wt.-% to 70 wt.-%, more preferably from 5 wt.-% to 50 wt.-%, even more preferably from 5 wt.-% to 40 wt.-%, and most preferably from 10 wt.-% to 30 wt.-%, based on the total weight of the delivery system,
the second hydromagnesite is present in an amount from 1 wt.-% to 99 wt.-%, preferably from 30 wt.-% to 99 wt.-%, more preferably from 50 wt.-% to 95 wt.-%, even more preferably from 60 wt.-% to 95 wt.-%, and most preferably from 70 wt.-% to 90 wt.-%, based on the total weight of the delivery system, and
the delivery system further comprises a disintegration agent, wherein the disintegration agent is present in an amount from 0.3 to 10 wt.-%, preferably from 0.5 to 8 wt.-%, more preferably from 1 wt.-% to 5 wt.-%, based on the total weight of the delivery system.

According to embodiment, a delivery system is provided comprising a first hydromagnesite, wherein the first hydromagnesite is an unloaded hydromagnesite, and a second hydromagnesite, wherein the second hydromagnesite is loaded with at least one active agent, wherein
the first hydromagnesite is present in an amount from 1 wt.-% to 99 wt.-%, preferably from 1 wt.-% to 70 wt.-%, more preferably from 5 wt.-% to 50 wt.-%, even more preferably from 5 wt.-% to 40 wt.-%, and most preferably from 10 wt.-% to 30 wt.-%, based on the total weight of the delivery system,
the second hydromagnesite is present in an amount from 1 wt.-% to 99 wt.-%, preferably from 30 wt.-% to 99 wt.-%, more preferably from 50 wt.-% to 95 wt.-%, even more preferably from 60 wt.-% to 95 wt.-%, and most preferably from 70 wt.-% to 90 wt.-%, based on the total weight of the delivery system,
the delivery system further comprises a disintegration agent, wherein the disintegration agent is present in an amount from 0.3 to 10 wt.-%, preferably from 0.5 to 8 wt.-%, more preferably from 1 wt.-% to 5 wt.-%, based on the total weight of the delivery system, and
the at least one active agent is present in an amount of at least 0.1 wt.-%, preferably at least 0.3 wt.-%, more preferably at least 0.6 wt.-%, and most preferably at least 1 wt.-%, based on the total weight of the delivery system.

According to another embodiment, a delivery system is provided comprising a first hydromagnesite, wherein the first hydromagnesite is an unloaded hydromagnesite, and a second hydromagnesite, wherein the second hydromagnesite is loaded with at least one active agent, wherein
the first hydromagnesite is present in an amount from 1 wt.-% to 99 wt.-%, preferably from 1 wt.-% to 70 wt.-%, more preferably from 5 wt.-% to 50 wt.-%, even more preferably from 5 wt.-% to 40 wt.-%, and most preferably from 10 wt.-% to 30 wt.-%, based on the total weight of the first hydromagnesite and the second hydromagnesite,
the second hydromagnesite is present in an amount from 1 wt.-% to 99 wt.-%, preferably from 30 wt.-% to 99 wt.-%, more preferably from 50 wt.-% to 95 wt.-%, even more preferably from 60 wt.-% to 95 wt.-%, and most preferably from 70 wt.-% to 90 wt.-%, based on the total weight of the first hydromagnesite and the second hydromagnesite, and
the delivery system further comprises a disintegration agent, wherein the disintegration agent is present in an amount from 0.3 to 10 wt.-%, preferably from 0.5 to 8 wt.-%, more preferably from 1 wt.-% to 5 wt.-%, based on the total weight of the first hydromagnesite and the second hydromagnesite.

According to a further embodiment, a delivery system is provided comprising a first hydromagnesite, wherein the first hydromagnesite is an unloaded hydromagnesite, and a second hydromagnesite, wherein the second hydromagnesite is loaded with at least one active agent, wherein
the first hydromagnesite is present in an amount from 1 wt.-% to 99 wt.-%, preferably from 1 wt.-% to 70 wt.-%, more preferably from 5 wt.-% to 50 wt.-%, even more preferably from 5 wt.-% to 40 wt.-%, and most preferably from 10 wt.-% to 30 wt.-%, based on the total weight of the first hydromagnesite and the second hydromagnesite,
the second hydromagnesite is present in an amount from 1 wt.-% to 99 wt.-%, preferably from 30 wt.-% to 99 wt.-%, more preferably from 50 wt.-% to 95 wt.-%, even more preferably from 60 wt.-% to 95 wt.-%, and most preferably from 70 wt.-% to 90 wt.-%, based on the total weight of the first hydromagnesite and the second hydromagnesite,
the delivery system further comprises a disintegration agent, wherein the disintegration agent is present in an amount from 0.3 to 10 wt.-%, preferably from 0.5 to 8 wt.-%, more preferably from 1 wt.-% to 5 wt.-%, based on the total weight of the first hydromagnesite and the second hydromagnesite, and
the at least one active agent is present in an amount of at least 0.1 wt.-%, preferably at least 0.3 wt.-%, more preferably at least 0.6 wt.-%, and most preferably at least 1 wt.-%, based on the total weight of the first hydromagnesite and the second hydromagnesite.

The inventors of the present invention surprisingly found that a delivery system comprising a combination of unloaded and loaded hydromagnesite particles can improve the release of active agents, especially into solutions. It was also found that the inventive delivery system shows excellent handling properties during production processes. For example, it was found that tablets of the inventive delivery system can be produced at high compaction frequencies. Moreover, it was found that the inventive delivery system provides the possibility of preparing a sprayable solution, which is particularly advantageous for agricultural applications.

The delivery system of the present invention may be provided in any form that is conventionally employed for the materials involved in the type of product to be produced. According to one embodiment, the delivery system is in the form of a powder, a tablet, a pellet, a bar, or granules, preferably in form of a tablet. According to a preferred embodiment the delivery system is in form of an effervescent tablet or a fast disintegrating tablet. Such forms and methods for their preparation are well known in the art and do not need to be described in more detail herein.

According to a further aspect of the present invention, a method for preparing a delivery system according to the present invention is provided, wherein the method comprises the steps of:
a) providing a first hydromagnesite, wherein the first hydromagnesite is an unloaded hydromagnesite,
b) providing a second hydromagnesite, wherein the second hydromagnesite is loaded with at least one active agent,
c) mixing the first hydromagnesite and the second hydromagnesite, and
d) optionally compacting the mixture obtained in step c).

The first hydromagnesite and the second hydromagnesite may be provided in solid or liquid form. For example, the first hydromagnesite and/or the second hydromagnesite are provided in form of a suspension, slurry, dispersion, paste, powder, a moist filter cake or in pressed or granulated form. According to a preferred embodiment, the first hydromagnesite and/or the second hydromagnesite are provided in dry form. The moisture content of the first hydromagnesite and/or second hydromagnesite can be, for example, in the range from 0.01 to 15 wt.-%, based on the total weight of the hydromagnesite, preferably in the range from 0.02 to 12 wt.-%, and more preferably in the range from 0.04 to 10 wt.-%.

According to a preferred method of the present invention, the first hydromagnesite and/or the second hydromagnesite are proved in compacted form. The compacting may be carried out by any suitable method known to the skilled person. Examples of suitable compacting methods are described further below.

The mixing step c) may be carried out by any suitable mixing means known in the art. For example, mixing step c) may take place in a mixer and/or blender, preferably a mixer such as a tumbling mixer or a shaker mixer.

In addition to the first hydromagnesite and the second hydromagnesite, further components may be added during the inventive method. According to one embodiment, the inventive method further comprises the step of adding an additional component, preferably a disintegration agent and/or a formulating aid, before and/or during and/or after step c).

In one embodiment, method step c) is carried out in that the first hydromagnesite and the second hydromagnesite are combined simultaneously with the additional component. Alternatively, a premix of the first hydromagnesite and the second hydromagnesite may be prepared in a first step, and subsequently, said premix is mixed with the additional component.

According to optional method step d) of the inventive method, the mixture obtained in step c) is compacted. The compacting may be carried out by any suitable method known to the skilled person.

According to one embodiment, the compacting is carried out by means of a roller compacter, preferably at a compaction pressure in the range from 2 to 20 bar. The term “roller compacting” refers to a process in which fine powders are forced between two counter rotating rolls and pressed into a solid compact or ribbon. The roller compacting can be carried out with any suitable roller compactor known to the skilled person. For example, roller compacting is carried out with a Fitzpatrick® Chilsonator IR220 roller compactor of the Fitzpatrick Company, USA.

According to one embodiment, the roller compacting is carried out at a roller compaction pressure from 2 to 20 bar, preferably from 4 to 15 bar, more preferably from 4 to 10 bar and most preferably from 4 to 7 bar. Additionally or alternatively, the feed rate and/or the roll speed during roller compacting step is/are adjusted such that a ribbon thickness of from 0.2 to 6 mm, preferably from 0.3 to 3 mm and more preferably from 0.4 to 1 mm is obtained. For example, the feed rate or the roll speed during roller compacting is adjusted such that a ribbon thickness of from 0.4 to 0.8 mm, preferably from 0.5 to 0.7 mm and most preferably of about 0.6 mm is obtained. Alternatively, the feed rate and the roll speed during roller compacting are adjusted such that a ribbon thickness of from 0.4 to 0.8 mm, preferably from 0.5 to 0.7 mm and most preferably of about 0.6 mm is obtained.

Subsequently, the compacted mixture obtained in the optional compacting step d) may subjected to a milling step. Milling may be carried out with any conventional mill known to the skilled person. For example, milling may be carried out with a FitzMill® from the Fitzpatrick Company, USA.

According to one embodiment, the method for preparing a delivery system according to the present invention may comprise a further step e) of sieving the compacted material obtained in step d). Such sieving can be carried out with any conventional sieving means known to the skilled person. The sieving can be carried out using one or more mesh sizes. Suitable mesh sizes are, but not limited to mesh sizes in the order of 710 μm, 500 μm, 180 μm, 90 μm, and 45 μm.

The sieved mixture thus may have a grain size of from 45 to 710 μm obtained by sieving on different mesh sizes, preferably by sieving with mesh sizes in the order of 710 μm, 500 μm, 180 μm, 90 μm, and 45 μm. For example, sieving is carried out with a Vibrating sieve tower of Vibro Retsch, Switzerland. It lies within the understanding of the present invention that other mesh sizes and combination of other mesh sized lie within the spirit of the present invention.

According to one embodiment, the method for preparing a delivery system according to the present invention may comprise a further step f) of tableting the mixture obtained in step c), or if present, the compacted mixtures of step d) or the sieved mixtures of step e). The tableting step f) may be carried out at a compressive pressure in the range from 0.5 to 500 MPa. Preferably, the tableting step f) may be carried out at a compressive pressure in the range from 1 to 400 MPa, and most preferably in the range from 10 to 400 MPa. For example, tableting step f) may be carried out at a compressive pressure in the range from 50 to 300 MPa, and most preferably in the range from 50 to 200 MPa or from 100 to 200 MPa. For example, tableting may be carried out with a tablet press such as a Styl'One 105 ml tablet press from Medelpharm, France.

According to a further aspect of the present invention, use of a delivery system according to the present invention in an agricultural application is provided. Examples of agricultural applications are fertilization, watering, control of plant growth, or pest control.

The delivery system according to the present invention may be applied according to methods well-known in the art. It may be used in dry form, e.g. as granulate or powder, or in liquid form, e.g. as a suspension, preferably an aqueous suspension. The suspension may be applied using a power sprayer, a manual sprayer, a watering can, sprinkler or an irrigation device. According to one embodiment, the suspension is a foliar. The dilution ratio is typically within a range of from 3:1 (water:delivery system) to 10 000:1, and preferably from 5:1 to 8 000:1. According to one embodiment the delivery system according to the present invention is used for the release of at least one active agent in an agricultural formulation.

According to a preferred embodiment, the delivery system according to the present invention is used for preparing a sprayable solution for agricultural application. According to an exemplary embodiment, the delivery system is provided in form of a tablet, preferably an effervescent tablet or fast disintegrating tablet, and is used for preparing a sprayable solution for agricultural application. The resulting solution can be sprayed onto agricultural land, non-agricultural land such as private gardens, forests, grasslands, golf courses, roadside trees, roads, road verges and marshes, or water systems such as ponds, reservoirs, rivers, watercourses and sewerage systems. The delivery system may be applied to the area where control of plant growth is desired, prior to or after emergence of the target plants, for example by spraying onto the surface of the soil or onto the foliage of the plants.

According to a further aspect of the present invention an agricultural formulation comprising a delivery system according to present invention is provided. The agricultural formulation may be a powder, a tablet, a pellet, a bar, granules, a solution, a suspension, or an emulsion. For the purpose of the present invention, the term “agricultural” means suitable for “agriculture”, which relates to the cultivation of plants in its broadest possible sense, i.e. it encompasses farming applications as well as non-farming applications such as private gardening or urban gardening.

The amount of the agricultural formulation applied is typically within a range from 0.001 kg/ha to 25 kg/ha, preferably 0.01 to 5 kg/ha, more preferably 0.1 to 2 kg/ha, and most preferably 0.2 to 1 kg/ha. The agricultural formulation containing the inventive delivery system, preferably suspended in water may comprise further additives like surfactants, defoamers, diluents, solvents, compatibility agents, thickeners, drift control agents, dyes, fragrance, and chelating agents.

According to the present invention it is preferred that the delivery system is used in a weight ratio of from 1 000:1 to 1:1, preferably 500:1 to 2:1, and most preferably 200:1 to 3:1 on a dry weights basis relative to the weight of the agricultural formulation.

The inventive agricultural formulation may preferably be used together with or may comprise additional agrochemical compounds, for example, formulations or compositions containing a copper source such as tribasic copper sulfate or tribasic copper chloride, preferably tribasic copper sulfate.

The scope and interest of the present invention will be better understood based on the following figures and examples which are intended to illustrate certain embodiments of the present invention and are non-limitative.

### EXAMPLES

### 1. Measurement Methods

### Particle Size Distribution

Volume determined median particle size d₅₀ (vol) and the volume determined top cut particle size d₉₈ (vol) was evaluated using a Malvern Mastersizer 3000 Laser Diffraction System (Malvern Instruments Plc., Great Britain) equipped with an Aero S accessory. The d₅₀ (vol) or d₉₈ (vol) value indicates a diameter value such that 50% or 98% by volume, respectively, of the particles have a diameter of less than this value. The powders were dispersed in air with a standard disperser and a pressure of 2.0 bar. Measurements were conducted with red light for 10 s. For the analysis of the raw data, the models for non-spherical particle sizes using Mie theory was utilized, and a particle refractive index of 1.57, a density of 2.70 g/cm³, and an absorption index of 0.005 was assumed. The methods and instruments are known to the skilled person and are commonly used to determine particle size distributions of fillers and pigments.

### Specific Surface Area (SSA)

The specific surface area was measured via the BET method according to ISO 9277:2010 using nitrogen as adsorbing gas on a Micromeritics ASAP 2460 instrument from Micromeritics. The samples were pre-treated in vacuum (10-5 bar) by heating at 120° C. for a period of 60 min prior to measurement.

### Porosimetry

The specific pore volume was measured using a mercury intrusion porosimetry measurement using a Micromeritics Autopore V 9620 mercury porosimeter having a maximum applied pressure of mercury 414 MPa (60 000 psi), equivalent to a Laplace throat diameter of 0.004 μm (˜ nm). The equilibration time used at each pressure step is 20 seconds. The sample material is sealed in a 3 cm3 chamber powder penetrometer for analysis. The data are corrected for mercury compression, penetrometer expansion and sample material compression using the software Pore-Comp (Gane, P. A. C., Kettle, J. P., Matthews, G. P. and Ridgway, C. J., “Void Space Structure of Compressible Polymer Spheres and Consolidated Calcium Carbonate Paper-Coating Formulations”, Industrial and Engineering Chemistry Research, 35(5), 1996, p 1753-1764.).

The total pore volume seen in the cumulative intrusion data can be separated into two regions with the intrusion data from 214 μm down to about 1-4 μm showing the coarse packing of the sample between any agglomerate structures contributing strongly. Below these diameters lies the fine interparticle packing of the particles themselves. If they also have intraparticle pores, then this region appears bi-modal, and by taking the specific pore volume intruded by mercury into pores finer than the modal turning point, i.e. finer than the bi-modal point of inflection, the specific intraparticle pore volume is defined. The sum of these three regions gives the total overall pore volume of the powder, but depends strongly on the original sample compaction/settling of the powder at the coarse pore end of the distribution.

By taking the first derivative of the cumulative intrusion curve the pore size distributions based on equivalent Laplace diameter, inevitably including pore-shielding, are revealed. The differential curves clearly show the coarse agglomerate pore structure region, the interparticle pore region and the intraparticle pore region, if present. Knowing the intraparticle pore diameter range it is possible to subtract the remainder interparticle and interagglomerate pore volume from the total pore volume to deliver the desired pore volume of the internal pores alone in terms of the pore volume per unit mass (specific pore volume). The same principle of subtraction, of course, applies for isolating any of the other pore size regions of interest.

### 2. Materials

### Hydromagnesite

d₅₀ (vol)=6.8 μm, d₉₈ (vol)=25 μm, SSA (BET)=42 m²/g, intra particle intruded specific pore volume: 1.263 cm³/g (for the pore diameter range of 0.004 to 0.53 μm).

### Active Agents

Pyrimethanil (CAS: 53112-28-0, product code: 077952), commercially available from Fluorochem Ltd., Great Britain.

1-((2-(4-Ethoxyphenyl)-2-methylpropoxy)methyl)-3-phenoxybenzene (Etofenprox) (CAS: 80844-07-1, product code: 215732), commercially available from Fluorochem Ltd., Great Britain.

2,4-Dichlorophenoxy acetic acid (2,4-D) (CAS:: 94-75-7, product code: 214787), commercially available from Fluorochem Ltd., Great Britain.

### Further Compounds

Acetone ≥99.5%, commercially available from Sigma-Aldrich Corporation, USA.

Dimethylamine (DMA) 40 wt.-% in H2O, commercially available from Sigma-Aldrich Corporation, USA.

### 3. Examples

### 3.1. Example 1—Preparation of Hydromagnesite Loaded with 2,4-dichlorophenoxy Acetic Acid

Hydromagnesite particles were loaded with different amounts of 2,4-dichlorophenoxy acetic acid (2,4-D), as indicated below, wherein the wt.-% of loading are based on the total weight of the hydromagnesite.

### 4.3 wt.-% Loading

A 20 wt.-% 2,4-D standard solution was prepared by weighting 35.95 g 2,4-D, adding 125.50 g water, adding 18.30 g DMA, shaking the mixture and putting the same into ultrasonic bath until diluted. 800 g hydromagnesite was loaded with 179.73 g of said 2,4-D standard solution.

Two times 89.875 g of the standard solution was added dropwise to each 400 g hydromagnesite during mixing in Lödige ploughshare mixer with a speed of 420 rpm. After loading it was continuously stirred for 5 min. Both batches were mingled and dried at 120° C. Solid content of the obtained loaded hydromagnesite was 99.32 wt.-%.

### 4.7 wt.-% Loading

A 20 wt.-% 2,4-D standard solution was prepared by weighting 36.99 g 2,4-D, adding 129.12 g water, adding 18.83 g DMA, shaking the mixture and putting the same into ultrasonic bath until diluted. 700 g hydromagnesite was loaded with 184.94 g of said 2,4-D standard solution.

Two times 92.47 g of the standard solution was added dropwise to each 350 g hydromagnesite during mixing in Lödige ploughshare mixer with a speed of 420 rpm. After loading it was continuously stirred for 5 min. Both batches were mingled and dried at 120° C. Solid content of the obtained loaded hydromagnesite was 99.65 wt.-%.

### 6.1 wt.-% Loading

A 20 wt.-% 2,4-D standard solution was prepared by weighting 38.98 g 2,4-D, adding 136.07 g water, adding 19.84 g DMA, shaking the mixture and putting the same into ultrasonic bath until diluted. 600 g hydromagnesite was loaded with 194.89 g of said 2,4-D standard solution.

Two times 97.45 g of the standard solution was added dropwise to each 300 g hydromagnesite during mixing in Lödige ploughshare mixer with a speed of 420 rpm. After loading it was continuously stirred for 5 min. Both batches were mingled and dried at 120° C. Solid content of the obtained loaded hydromagnesite was 99.44 wt.-%.

### 8.5 wt.-% Loading

A 20 wt.-% 2,4-D standard solution was prepared by weighting 41.80 g 2,4-D, adding 145.94 g water, adding 21.28 g DMA, shaking the mixture and putting the same into ultrasonic bath until diluted. 450 g hydromagnesite was loaded with 209.02 g of said 2,4-D standard solution.

The prepared standard solution was added dropwise to 450 g hydromagnesite during mixing in Lödige ploughshare mixer with a speed of 420 rpm. After loading it was continuously stirred for 5 min. The loaded hydromagnesite was dried at 120° C. Solid content of the obtained loaded hydromagnesite was 99.66 wt.-%.

### 14.2 wt.-% Loading

A 20 wt.-% 2,4-D standard solution was prepared by weighting 49.64 g 2,4-D, adding 173.33 g water, adding 25.17 g DMA, shaking the mixture and putting the same into ultrasonic bath until diluted. 300 g hydromagnesite was loaded with 248.25 g of said 2,4-D standard solution.

The prepared standard solution was added dropwise to 300 g hydromagnesite during mixing in Lödige ploughshare mixer with a speed of 420 rpm. After loading it was continuously stirred for 5 min. The loaded hydromagnesite was dried at 120° C. Solid content of the obtained loaded hydromagnesite was 99.54 wt.-%.

### 21.3 wt.-% Loading

A 20 wt.-% 2,4-D standard solution was prepared by weighting 54.13 g 2,4-D, adding 188.97 g water, adding 27.55 g DMA, shaking the mixture and putting the same into ultrasonic bath until diluted. 200 g hydromagnesite was loaded with 270.65 g of said 2,4-D standard solution.

The first half (135.33 g) of the prepared standard solution was added dropwise to 200 g hydromagnesite during mixing in Lödige ploughshare mixer with a speed of 420 rpm. After loading it was continuously stirred for 5 min. The loaded hydromagnesite (11.5 wt.-% loaded) was dried at 120° C. The second half of the prepared standard solution was added dropwise to said loaded hydromagnesite during mixing in Lödige ploughshare mixer with a speed of 420 rpm. After loading it was continuously stirred for 5 min and dried at 120° C. Solid content of the obtained loaded hydromagnesite was 98.54 wt.-%.

### 3.2. Example 2—Preparation of Hydromagnesite Loaded with Etofenprox

Hydromagnesite particles were loaded with different amounts of etofenprox, as indicated below, wherein the wt.-% of loading are based on the total weight of the hydromagnesite.

### 1.1 wt.-% Loading

A 70 wt.-% etofenprox standard solution was prepared by weighting 8.90 g etofenprox, adding 3.81 g acetone, shaking the mixture and putting the same into ultrasonic bath until diluted. 800 g hydromagnesite was loaded with 12.71 g of said etofenprox standard solution.

Two times 6.35 g of the standard solution was added dropwise to each 400 g hydromagnesite during mixing in Lödige ploughshare mixer with a speed of 420 rpm. After loading it was continuously stirred for 5 min. Both batches were mingled and dried at 60° C. Solid content of the obtained loaded hydromagnesite was 98.98 wt.-%.

### 1.2% Loading

A 70 wt.-% etofenprox standard solution was prepared by weighting 8.50 g etofenprox, adding 3.81 g acetone, shaking the mixture and putting the same into ultrasonic bath until diluted. 700 g hydromagnesite was loaded with 12.15 g of said etofenprox standard solution.

Two times 6.07 g of the standard solution was added dropwise to each 350 g hydromagnesite during mixing in Lödige ploughshare mixer with a speed of 420 rpm. After loading it was continuously stirred for 5 min. Both batches were mingled and dried at 60° C. Solid content of the obtained loaded hydromagnesite was 98.23 wt.-%.

### 1.5% Loading

A 70 wt.-% etofenprox standard solution was prepared by weighting 8.38 g etofenprox, adding 3.59 g acetone, shaking the mixture and putting the same into ultrasonic bath until diluted. 550 g hydromagnesite was loaded with 11.97 g of said etofenprox standard solution.

Two times 5.99 g of the standard solution was added dropwise to each 275 g hydromagnesite during mixing in Lödige ploughshare mixer with a speed of 420 rpm. After loading it was continuously stirred for 5 min. Both batches were mingled and dried at 60° C. Solid content of the obtained loaded hydromagnesite was 98.43 wt.-%.

### 2.1% Loading

A 70 wt.-% etofenprox standard solution was prepared by weighting 8.58 g etofenprox, adding 3.67 g acetone, shaking the mixture and putting the same into ultrasonic bath until diluted. 400 g hydromagnesite was loaded with 12.26 g of said etofenprox standard solution.

The prepared standard solution was added dropwise to 400 g hydromagnesite during mixing in Lödige ploughshare mixer with a speed of 420 rpm. After loading it was continuously stirred for 5 min and dried at 60° C. Solid content of the obtained loaded hydromagnesite was 98.75 wt.-%.

### 3.3. Example 3—Preparation of Hydromagnesite Loaded with Pyrimethanil

Hydromagnesite particles were loaded with different amounts of pyrimethanil, as indicated below, wherein the wt.-% of loading are based on the total weight of the hydromagnesite.

### Preparation of Pyrimethanil Standard Solution

A 20 wt.-% pyrimethanil standard solution was prepared by adding 49 g pyrimethanil into 196 g acetone and putting the mixture into ultrasonic bath until complete dilution.

### 1.5 wt.-% Loading

800 g hydromagnesite was loaded with 60.91 g pyrimethanil standard solution. Twice 30.45 g of the standard solution was added dropwise to 400 g hydromagnesite during mixing in a Lödige ploughshare mixer with a speed of 420 rpm. After loading, it was continuously stirred for 5 min. Both batches were mingled and dried at 40° C. and 500 mbar for 24 h. The solid content of the obtained loaded hydromagnesite was 96.25 wt.-%.

### 1.7 wt.-% Loading

700 g hydromagnesite was loaded with 60.53 g pyrimethanil standard solution. Twice 30.27 g of the standard solution was added dropwise to 350 g hydromagnesite during mixing in Lödige ploughshare mixer with a speed of 420 rpm. After loading, it was continuously stirred for 5 min. Both batches were mingled and dried at 40° C. and 500 mbar for 24 h. Solid content of the obtained loaded hydromagnesite was 96.04 wt.-%.

### 2.1 wt.-% Loading

550 g hydromagnesite was loaded with 58.99 g pyrimethanil standard solution. Twice 29.5 g of the standard solution was added dropwise to 275 g hydromagnesite during mixing in Lödige ploughshare mixer with a speed of 420 rpm. After loading, it was continuously stirred for 5 min. Both batches were mingled and dried at 40° C. and 500 mbar for 24 h. Solid content of the obtained loaded hydromagnesite was 96.24 wt.-%.

### 3.0 wt.-% Loading

400 g hydromagnesite was loaded with 61.89 g pyrimethanil standard solution. 61.89 g of the standard solution was added dropwise to 400 g hydromagnesite during mixing in Lödige ploughshare mixer with a speed of 420 rpm. After loading, it was continuously stirred for 5 min and dried at 40° C. and 500 mbar for 24 h. Solid content of the obtained loaded hydromagnesite was 96.00 wt.-%.

### 3.4. Example 4—Preparation of Delivery Systems Pre-Compaction

Each of the loaded hydromagnesite powders prepared according to Examples 1 to 3 as well as unloaded hydromagnesite were subjected to a pre-compaction step, during which 1 wt.-%, based on the total weight of hydromagnesite, of the disintegration agent croscarmellose sodium (Vivasol, JRS PHARMA GmbH+Co. KG, Germany) was added. The pre-compaction step was carried out on a Polygran® machine (FormiChem, GmbH, Neuburg a.d. Donau, Germany). Machine parameters of each pre-compaction test are summarized in Table 1 below.

### Sieving

The pre-compacted mixtures were sieved with the following sieve sizes: 45 μm, 100 μm, 200 μm, 500 μm, 1000 μm, 1600 μm, wherein the diameter of each sieve was 20 cm. The pre-compacted mixtures were sieved in 120 g—steps and the fractions of the different particle size ranges were collected. The results of the sieving step are shown in Tables 2 and 3 below.

### Tabletting

Tablets having a diameter of 20 mm and a weight of 2 g were produced on a STYL'One Machine (Medelpharm, France) from a mixture of the particle diameter fractions 45-100 μm, 100-200 μm, 200-500 μm, 500-1000 μm, and 1000-1600 μm. Magnesium stearate was added to the hydromagnesite powder before compaction in order to facilitate the expulsion of the tablets from the machine. In order to improve the stability of the tablets containing hydromagnesite loaded with 2,4-D, 20 wt.-% microcrystalline cellulose were added (Vivapur 105, JRS PHARMA GmbH+Co. KG, Germany).

To obtain tablets without friable edges, bevelled punches were used. Each tablets set was characterized according pharma standards methods: hardness, disintegration time, friability and thickness. Furthermore, tests under production conductions were performed but no significant differences were observed with a production speed of ca. 400′000 tablets/hour and the test method production speed, which is surprising in view of the shorter compaction time. The results are presented in Tables 6 to 9 below.

For the production cadence test, a compaction force of 35 kN was targeted as this presents the first stable/best state of test production parameters. The produced tablets were subsequently used for in-vivo testes.

TABLE 1
Machine parameters of the pre-compaction step.

| | | | | | | | | | | Speed of |
|---|---|---|---|---|---|---|---|---|---|---|
| Active agent | | | Press | Speed of | Screw | Screw | Roll | Sieve | | granulator |
| | Amount | | force | press rollers | speed | type | distance | size | Sieve | rotor |
| Compound | [wt.-%]^{a} | Milling | [kN/cm] | [U/min] | [U/min] | [No.] | [mm] | [mm] | type | [U/min] |
| — | — | Ripple | 5 | 5 | 120 | 4 | 2 | 3 | square | 40 |
| — | — | | 10 | 3-4 | 95 | 2 | | | | 25 |
| — | — | | 14 | 4-5 | 95 | 2 | | | | 25 |
| 2,4-D | 4.3 | Ripple | 10 | 5 | 65 | 4 | 2 | 2 | square | 25 |
| 2,4-D | 4.7 | | | 4.5 | 60 | | | | | 25 |
| 2,4-D | 6.1 | | | 4.5 | 60 | | | | | 25 |
| 2,4-D | 8.5 | | | 4.5 | 60 | | | | | 25 |
| 2.4-D | 14.2 | | | 4.5 | 65 | | | | | 30 |
| 2,4-D | 21.3 | | | 4.5 | 60 | | | | | 30 |
| Etofenprox | 1.1 | Ripple | 10 | 5 | 60 | 2 | 2 | 2 | square | 25 |
| Etofenprox | 1.2 | | | | | | | | | |
| Etofenprox | 1.5 | | | | | | | | | |
| Etofenprox | 2.1 | | | | | | | | | |
| Pyrimethanil | 1.5 | Ripple | 10 | 5 | 60 | 2 | 2 | 2 | square | 25 |
| Pyrimethanil | 1.7 | | | 5 | 60 | | | | | |
| Pyrimethanil | 2.1 | | | 4.5 | 65 | | | | | |
| Pyrimethanil | 3.0 | | | 4 | 65 | | | | | |

^{a}wt.-% is based on total amount of loaded hydromagnesite.

TABLE 2
Results of sieving.

| | Sample | | | | | | |
|---|---|---|---|---|---|---|---|
| | pure | | | | | | |
| | hydromagnesite | V1.1 | V1.2 | V1.3 | V1.4 | V1.5 | V1.6 |
| Active agent | — | 2.4 D | | | | | |
| Amount of active agent [wt.-%] | — | 4.3 | 4.7 | 6.1 | 8.5 | 14.2 | 21.3 |
| Particle diameter <45 μm [g] | 1.4 | 8.7 | 13.8 | 15.6 | 5.1 | 8.6 | 3.9 |
| Particle diameter 45-100 μm [g] | 63.0 | 197.6 | 237.2 | 268.1 | 225.1 | 235.0 | 170.3 |
| Particle diameter 100-200 μm [g] | 116.1 | 64.5 | 52.8 | 49.7 | 57.2 | 54.8 | 68.6 |
| Particle diameter 200-500 μm [g] | 211.0 | 141.6 | 136.5 | 135.4 | 143.5 | 135.5 | 144.2 |
| Particle diameter 500-1000 μm [g] | 141.0 | 250.0 | 242.5 | 249.5 | 251.9 | 238.1 | 241.8 |
| Particle diameter 1000-1600 μm [g] | 239.6 | 430.0 | 382.6 | 359.7 | 348.1 | 344.2 | 361.5 |
| Particle diameter >1600 μm [g] | 182.5 | 320.4 | 326.6 | 333.1 | 370.1 | 397.2 | 416.6 |
| Total | 954.6 | 1412.8 | 1392 | 1411.1 | 1401 | 1413.4 | 1406.9 |
| Particle diameter 45-1600 μm [g] | 770.7 | 1083.7 | 1051.6 | 1062.4 | 1025.8 | 1007.6 | 986.4 |
| Particle diameter 100-1600 μm [g] | 707.7 | 886.1 | 814.4 | 794.3 | 800.7 | 772.6 | 816.1 |

TABLE 3
Results of sieving.

| Sample | V2.1 | V2.2 | V2.3 | V2.4 | V3.1 | V3.2 | V3.3 | V3.4 |
|---|---|---|---|---|---|---|---|---|
| Active agent | Etofenprox | | | | Pyrimethanil | | | |
| Amount of active agent [wt.-%] | 1.1 | 1.2 | 1.5 | 2.1 | 1.5 | 1.7 | 2.1 | 3 |
| Particle diameter <45 μm [g] | | | | 0.2 | 0.1 | 0.4 | 0.1 | 0.2 |
| Particle diameter 45-100 μm [g] | 48.2 | 56.4 | 61.2 | 41.4 | 26.0 | 47.8 | 38.4 | 41.5 |
| Particle diameter 100-200 μm [g] | 67.0 | 101.8 | 89.9 | 80.6 | 84.7 | 84.4 | 86.4 | 110.1 |
| Particle diameter 200-500 μm [g] | 150.2 | 188.8 | 179.0 | 196.1 | 161.8 | 208.4 | 210.0 | 191.3 |
| Particle diameter 500-1000 μm [g] | 217.9 | 158.0 | 236.4 | 268.7 | 179.0 | 263.1 | 264.1 | 262.9 |
| Particle diameter 1000-1600 μm [g] | 358.1 | 434.5 | 453.4 | 461.2 | 310.3 | 262.9 | 371.1 | 366.6 |
| Particle diameter >1600 μm [g] | 308.9 | 350.0 | 390.4 | 391.1 | 189.7 | 407.2 | 414.4 | 427.6 |
| Total | 1151.4 | 1290.7 | 1411.8 | 1439.3 | 951.6 | 1274.2 | 1384.5 | 1400.2 |
| Particle diameter 45-1600 μm [g] | 841.4 | 939.5 | 1019.9 | 1048.0 | 761.8 | 866.6 | 970.0 | 972.4 |
| Particle diameter 100-1600 μm [g] | 793.2 | 883.1 | 958.7 | 1006.6 | 735.8 | 818.8 | 931.6 | 930.9 |

TABLE 4
Tabletting machine parameters.

| Active agent | — | 2,4-D | Etofenprox | Pyrimethanil | Production conditions |
|---|---|---|---|---|---|
| Batch of final product | 2 gram | 2.5 gram | 2 gram | 2 gram | 2.5 gram (2.4-D) |
| | D20 | D20 | D20 | D20 | 2 gram (Etofenprox, |
| | bevel edged | bevel edged | bevel edged | bevel edged | Pyramethanil) |
| | | | | | D20 |
| | | | | | bevel edged |
| Coupling number | N/A | N/A | N/A | N/A | N/A |
| Product tablets | | | | | Automatically |
| Number of cycles to execute | 45 | 50 | 50 | 50 | 100 |
| “Zero” upper punch moving | 0 | 0 | 0 | 0 | 0 |
| “Zero” lower punch moving | 0 | 0 | 0 | 0 | 0 |
| Acquisition frequency (Hz) | 2000 | 2000 | 2000 | 2000 | 2000 |
| Security level on | 9000 | 9000 | 9000 | 9000 | 9000 |
| tablet ejection (N) | | | | | |
| Security level on | 51 | 51 | 51 | 51 | 51 |
| punches (KN) | | | | | |
| Security level on | 200 | 200 | 200 | 200 | 200 |
| Take-off Force (N) | | | | | |
| Max force for tablet | N/A | N/A | N/A | N/A | 38 |
| sorting (kN) | | | | | |
| Min force for tablet | N/A | N/A | N/A | N/A | 30 |
| sorting (kN) | | | | | |
| Punch | OMYA D20 mm | OMYA D20 mm | OMYA D20 mm | OMYA D20 mm | OMYA D20 mm |
| | bevel edged | bevel edged | bevel edged | bevel edged | bevel edged |
| Simulated machine | Fette 3090i-Euro D | Fette 3090i-Euro D | Fette 3090i-Euro D | Fette 3090i-Euro D | Fette 3090i-Euro D |
| STYL'One Evolution | 5 | 5 | 5 | 5 | 68 |
| speed (rpm) | | | | | |
| Feeding system speed | N/A | N/A | N/A | N/A | N/A |
| Temperature (°C): | 22.9 | 22.9 | 22.9 | 22.9 | 22.9 |
| Humidity (% RH): | 40 | 40 | 40 | 40 | 40 |
| Simulated speed | 29400 | 29400 | 29400 | 29400 | 399840 |

TABLE 5
Composition of delivery systems prepared according to Example 4.

| | | | | | | | Vivasol | Vivasol | Magnesium |
|---|---|---|---|---|---|---|---|---|---|
| | | | | | | | Formichem | Medelpharm | Stearate |
| | | | | | | | [wt.-%]^{b} | [wt.-%]^{c} | [wt.-%]^{b} |
| | | | | | | | (added | (added | (added |
| | Active agent | | Loaded | | Unloaded | | during | during pre- | during |
| | | Amount | hydromagnesite | | hydromagnesite | | tabletting | compaction | tabletting |
| Sample | Compound | [wt.-%]^{a} | [g] | [wt.-%]^{c} | [g] | [wt.-%]^{c} | step) | step) | step) |
| V1.1 (comp.) | 2,4-D | 4.3 | 1520 | 100 | 0 | 0 | 1 | 1 | 0.5 |
| V1.2 | 2,4-D | 4.7 | 1368 | 90 | 152 | 10 | 1 | 1 | 0.5 |
| V1.3 | 2,4-D | 6.1 | 1064 | 70 | 465 | 30 | 1 | 1 | 0.5 |
| V1.4 | 2,4-D | 8.5 | 760 | 50 | 760 | 50 | 1 | 1 | 0.5 |
| V1.5 | 2,4-D | 14.2 | 456 | 30 | 1064 | 70 | 1 | 1 | 0.5 |
| V1.6 | 2,4-D | 21.3 | 304 | 20 | 1216 | 80 | 1 | 1 | 0.5 |
| V2.1 (comp.) | Etofenprox | 1.1 | 1520 | 100 | 0 | 0 | 1 | 1 | 0.5 |
| V2.2 | Etofenprox | 1.2 | 1368 | 90 | 152 | 10 | 1 | 1 | 0.5 |
| V2.3 | Etofenprox | 1.5 | 1064 | 70 | 456 | 30 | 1 | 1 | 0.5 |
| V2.4 | Etofenprox | 2.1 | 760 | 50 | 760 | 50 | 1 | 1 | 0.5 |
| V3.1 (comp.) | Pyrimethanil | 1.5 | 1520 | 100 | 0 | 0 | 1 | 1 | 0.5 |
| V3.2 | Pyrimethanil | 1.7 | 1368 | 90 | 152 | 10 | 1 | 1 | 0.5 |
| V3.3 | Pyrimethanil | 2.1 | 1064 | 70 | 456 | 30 | 1 | 1 | 0.5 |
| V3.4 | Pyrimethanil | 3.0 | 760 | 50 | 760 | 50 | 1 | 1 | 0.5 |

^{a}wt.-% is based on total weight of loaded hydromagnesite;
^{b}wt.-% is based on total weight of delivery system,
^{c}wt.-% is based on total weight of the loaded and unloaded hydromagnesite,
comp.: comparative.

TABLE 6
Characteristics of produced tablets without loaded hydromagnesite.

| Main compression | | Disintegration | | Thick- |
|---|---|---|---|---|
| force | Hardness | time | Friability | ness |
| 15.34 | 263.40 | 19.00 | 0.61 | 6.94 |
| 23.50 | 350.50 | 20.00 | 0.17 | 5.99 |
| 35.03 | 521.20 | 21.00 | 0.14 | 5.57 |
| 45.20 | 670.10 | 20.00 | 0.09 | 5.26 |

TABLE 7
Characteristics of produced tablets comprising 2,4-D loaded hydromagnesite.

| | Sample | | | | | | |
|---|---|---|---|---|---|---|---|
| | | | | | | | V1.3 |
| | V1.1 | V1.2 | V1.3 | V1.4 | V1.5 | V1.6 | production |
| Main compression force (kN) | 14.95 | 14.93 | 15.58 | 14.09 | 13.62 | 13.91 | — |
| Thickness (mm) | 7.90 | 7.92 | 7.96 | 7.73 | 7.70 | 7.66 | — |
| Hardness (N) | 82.71 | 82.00 | 98.60 | 95.70 | 101.60 | 117.20 | — |
| Friability (%) | 2.41 | 2.09 | 1.31 | 1.39 | 1.31 | 1.10 | — |
| Disintegration time (s) | 22 | 25 | 22 | 24 | 30 | 24 | — |
| Main compression force (kN) | 24.22 | 23.65 | 25.83 | 22.46 | 21.81 | 22.52 | — |
| Thickness (mm) | 7.22 | 7.24 | 7.30 | 7.01 | 7.00 | 6.96 | — |
| Hardness (N) | 167.10 | 168.00 | 198.50 | 192.70 | 198.20 | 224.70 | — |
| Friability (%) | 0.57 | 0.45 | 0.28 | 0.30 | 0.36 | 0.30 | — |
| Disintegration time (s) | 38 | 30 | 34 | 33 | 38 | 35 | — |
| Main compression force (kN) | 32.68 | 32.34 | 35.19 | 32.55 | 31.92 | 32.28 | 33.67 |
| Thickness (mm) | 6.73 | 6.75 | 6.82 | 6.61 | 6.58 | 6.52 | 6.82 |
| Hardness (N) | 266.60 | 279.00 | 325.30 | 301.90 | 319.80 | 357.20 | 213.00 |
| Friability (%) | 0.16 | 0.16 | 0.16 | 0.18 | 0.11 | 0.12 | 0.61 |
| Disintegration time (s) | 40 | 42 | 50 | 35 | 42 | 44 | 42 |
| Main compression force (kN) | 41.71 | 40.08 | 43.82 | 42.93 | 41.07 | 41.22 | — |
| Thickness (mm) | 6.40 | 6.38 | 6.50 | 6.31 | 6.23 | 6.19 | — |
| Hardness (N) | 391.00 | 386.20 | 429.60 | 425.60 | 444.00 | 493.70 | — |
| Friability (%) | 0.10 | 0.12 | 0.10 | 0.10 | 0.10 | 0.10 | — |
| Disintegration time (s) | 50 | 54 | 60 | 60 | 55 | 48 | — |

TABLE 8
Characteristics of produced tablets comprising etofenprox loaded
hydromagnesite.

| | | | | | V2.3 |
|---|---|---|---|---|---|
| Sample | V2.1 | V2.2 | V2.3 | V2.4 | production |
| Main compression | 13.93 | 13.93 | 14.35 | 14.47 | — |
| force (kN) | | | | | |
| Thickness (mm) | 6.74 | 6.62 | 6.54 | 6.54 | — |
| Hardness (N) | 58.10 | 62.90 | 55.20 | 56.50 | — |
| Friability (%) | 2.74 | 2.87 | 4.40 | 3.10 | — |
| Disintegration time (s) | 21 | 24 | 18 | 22 | — |
| Main compression | 23.59 | 23.49 | 24.19 | 24.17 | — |
| force (kN) | | | | | |
| Thickness (mm) | 6.15 | 6.03 | 5.99 | 6.01 | — |
| Hardness (N) | 132.40 | 133.30 | 112.80 | 117.90 | — |
| Friability (%) | 0.59 | 0.55 | 0.50 | 0.44 | — |
| Disintegration time (s) | 22 | 22 | 20 | 22 | — |
| Main compression | 33.08 | 32.54 | 33.53 | 35.70 | 37.38 |
| force (kN) | | | | | |
| Thickness (mm) | 5.71 | 5.63 | 5.63 | 5.54 | 5.57 |
| Hardness (N) | 226.90 | 227.30 | 202.10 | 224.30 | 157.20 |
| Friability (%) | 0.26 | 0.28 | 0.24 | 0.26 | — |
| Disintegration time (s) | 28 | 26 | 22 | 24 | 20 |
| Main compression | 41.53 | 41.21 | 42.60 | 42.19 | — |
| force (kN) | | | | | |
| Thickness (mm) | 5.40 | 5.29 | 5.30 | 5.32 | — |
| Hardness (N) | 353.00 | 336.80 | 307.00 | 290.70 | — |
| Friability (%) | 0.14 | 0.15 | 0.21 | 0.20 | — |
| Disintegration time (s) | 28 | 26 | 25 | 24 | — |

TABLE 9
Characteristics of produced tablets comprising pyrimethanil loaded
hydromagnesite.

| | | | | | V3.3 |
|---|---|---|---|---|---|
| Sample | V3.1 | V3.2 | V3.3 | V3.4 | production |
| Main compression | 15.23 | 15.05 | 14.98 | 14.74 | — |
| force (kN) | | | | | |
| Thickness (mm) | 6.90 | 6.66 | 6.44 | 6.54 | — |
| Hardness (N) | 110.00 | 73.70 | 66.50 | 65.90 | — |
| Friability (%) | 1.03 | 2.21 | 2.11 | 2.19 | — |
| Disintegration time (s) | 27 | 32 | 24 | 23 | — |
| Main compression | 22.90 | 25.35 | 24.22 | 26.20 | — |
| force (kN) | | | | | |
| Thickness (mm) | 6.29 | 6.07 | 5.88 | 5.86 | — |
| Hardness (N) | 196.50 | 152.80 | 128.90 | 148.00 | — |
| Friability (%) | 0.40 | 0.55 | 0.64 | 0.45 | — |
| Disintegration time (s) | 20 | 26 | 24 | 24 | — |
| Main compression | 32.20 | 35.00 | 34.07 | 36.93 | 34.41 |
| force (kN) | | | | | |
| Thickness (mm) | 5.79 | 5.66 | 5.48 | 5.52 | 5.47 |
| Hardness (N) | 328.70 | 250.70 | 218.80 | 238.20 | 224.70 |
| Friability (%) | 0.19 | 0.27 | 0.25 | 0.22 | — |
| Disintegration time (s) | 22 | 26 | 22 | 24 | 22 |
| Main compression | 40.66 | 44.69 | 42.37 | 46.05 | — |
| force (kN) | | | | | |
| Thickness (mm) | 5.41 | 5.35 | 5.19 | 5.28 | — |
| Hardness (N) | 460.10 | 368.10 | 309.50 | 337.60 | — |
| Friability (%) | 0.14 | 0.17 | 0.18 | 0.16 | — |
| Disintegration time (s) | 26 | 26 | 24 | 26 | — |

### 3.5. Example 5—Active Agent Release Tests

### 3.5.1 Calibration for Release Analysis 2,4-D

A standard solution was made for the calibration curve determination. 2,4-D (100 mg) were suspended in 5 ml water. DMA (50.9 mg) was added and the volume was completed to 10 ml with water. The mixture was stirred until the substance was dissolved. Standard solutions were prepared, as shown in Table 10 below. The standard solutions were measured at a wavelength of 284 nm using a Sotax AT7 smart & Sotax CP coupled with a Sotax Specord 200 Plus.

TABLE 10
Standard solutions of 2,4-D.

| | | volume taken | End | |
|---|---|---|---|---|
| | concentration | from parent | volume | Absorbance |
| Standard | [mg/ml] | solution [ml] | [ml] | [AU/cm] |
| 0 | 0.000 | 0 | 50 | — |
| 1 | 0.010 | 0.10 | 50 | 0.09264663 |
| 2 | 0.020 | 0.25 | 50 | 0.23127039 |
| 3 | 0.050 | 0.50 | 50 | 0.46101192 |
| 4 | 0.075 | 0.75 | 50 | 0.69199926 |
| 5 | 0.100 | 1.00 | 50 | 0.92696790 |
| 6 | 0.120 | 1.20 | 50 | 1.10111210 |
| 7 | 0.140 | 1.40 | 50 | 1.29277729 |

### Pyrimethanil

A standard solution of 50 mg/l Pyrimethanil was prepared for calibration curve determination. Pyrimethanil (25.1 mg) was dissolved into 500 ml water. The mixture was heated up to 40° C. and stirred until complete dilution of the active. Standard solutions were prepared, as shown in Table 11 below. The standard solutions were measured at a wavelength of 269 nm using a Sotax AT7 smart & Sotax CP coupled with a Sotax Specord 200 Plus.

TABLE 11
Standard solutions of pyrimethanil.

| | | volume taken | End | |
|---|---|---|---|---|
| | concentration | from parent | volume | Absorbance |
| Standard | [mg/l] | solution [ml] | [ml] | [AU/cm] |
| 0 | 0.0 | 0.0 | 50 | — |
| 1 | 1.0 | 1.0 | 50 | 0.10704187 |
| 2 | 2.0 | 2.0 | 50 | 0.21083162 |
| 3 | 4.0 | 4.0 | 50 | 0.41998053 |
| 4 | 6.0 | 6.0 | 50 | 0.62807924 |
| 5 | 8.0 | 8.0 | 50 | 0.83502158 |
| 6 | 10.0 | 10.0 | 50 | 1.04382514 |
| 7 | 12.0 | 12.0 | 50 | 1.25593258 |

### 3.5.2. Release Measurements

### Pyrimethanil

### Essay 1

Essay 1 was started with following parameters:

| | |
|---|---|
| Test Volume | 1000 ml water |
| Stirrer speed | 100 rpm |
| Room temperature | 25° C. |
| Time point | 2, 4, 6, 8, 10, 15, 20, 25, 30, 35, 40, 45, |
| | 50, 55, 60 min |
| Vessel 1 + 2 | Pure pyrimethanil 30.2 mg/30.4 mg |
| Vessel 3 + 4 | Tablet 1.5 wt .-% (sample V3.1), |
| | 35 kN 2.0490 g/2.0573 g |
| Vessel 5 + 6 | Tablet 2.1 wt .-% (sample V3.3), |
| | 35 kN 1.9701 g/1.9612 g |

Filter for vessel 3-6 were changed after the 4^{th}, 7^{th}, 10^{th} and 12^{th} sampling.

### Essay 2

Essay 2 was started with following parameters:

| | |
|---|---|
| Test Volume | 1000 ml water |
| Stirrer speed | 100 rpm |
| Room temperature | 25° C. |
| Time point | 2, 4, 6, 8, 10, 15, 20, 25, 30, 35, 40, |
| | 45, 50, 55, 60 min |
| Vessel 1 + 2 | Pure hydromagnesite tablet |
| | (unloaded) 2.0377 g/2.0139 g |
| Vessel 3 + 4 | Tablet 1.7 wt .-% (sample V3.2), |
| | 35 kN 2.0282 g/2.0620 g |
| Vessel 5 + 6 | Tablet 3.0 wt .-% (sample V3.4), |
| | 35 kN 2.0748 g/2.0863 g |

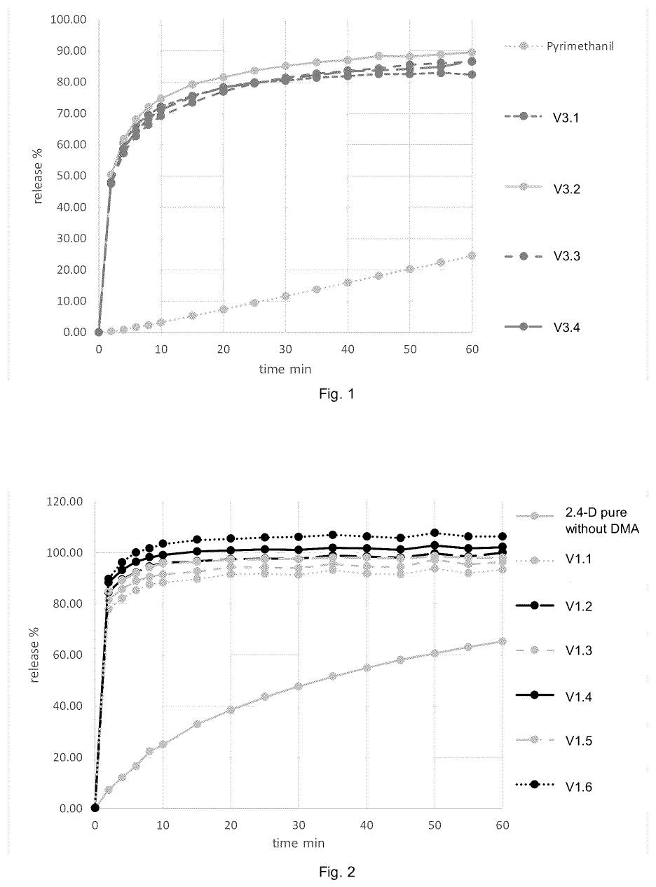

Filter for vessel 3-6 were changed after the 2^{th}, 5^{th}, 7^{th}, 10^{th} and 13^{th} sampling. The release results are shown in FIG. 1.

### 2,4-D

### Essay 1

Essay 1 was started with following parameters:

| | |
|---|---|
| Test Volume | 800 m water |
| Stirrer speed | 100 rpm |
| Room temperature | 25° C. |
| Time point | 2, 4, 6, 8, 10, 15, 20, 25, 30, 35, 40, 45, |
| | 50, 55, 60 min |
| Vessel 1 + 2 | 2,4-D pure without DMA 84.9 mg/84.9 mg |
| Vessel 3 + 4 | Tablet 4.3 wt .-% (sample V1.1), |
| | 35 kN 2.4493 g/2.4977 g |
| Vessel 5 + 6 | Tablet 6.1 wt .-% (sample V1.3), |
| | 35 kN 2.4715 g/2.5228 g |

Filter for vessel 3-6 were changed after the 3^{th}, 6^{th}, 7^{th} and 9^{th} sampling.

### Essay 2

Essay 2 was started with following parameters:

| | |
|---|---|
| Test Volume | 800 ml water |
| Stirrer speed | 100 rpm |
| Room temperature | 25° C. |
| Time point | 2, 4, 6, 8, 10, 15, 20, 25, 30, 35, 40, 45, |
| | 50, 55, 60 min |
| Vessel 1 + 2 | Pure hydromagnesite tablet (unloaded) |
| | 2.0666 g/2.0897 g |
| Vessel 3 + 4 | Tablet 8.5 wt .-% (sample V1.4), |
| | 35 kN 2.5090 g/2.5186 g |
| Vessel 5 + 6 | Tablet 21.3 wt .-% (sample V1.6), |
| | 35 kN 2.5328 g/2.5536 g |

Filter for all vessel were changed after the 3^{th}, 5^{th}, 7^{th}, 9^{th} and 11^{th} sampling.

### Essay 3

Essay 3 was started with following parameters:

| | |
|---|---|
| Test Volume | 800 ml water |
| Stirrer speed | 100 rpm |
| Room temperature | 25° C. |
| Time point | 2, 4, 6, 8, 10, 15, 20, 25, 30, 35, 40, |
| | 45, 50, 55, 60 min |
| Vessel 1 + 2 | Pure hydromagnesite tablet |
| | (unloaded) 2.0154 g/2.0958 g |
| Vessel 3 + 4 | Tablet 4.7 wt .-% (sample V1.2), |
| | 35 kN 2.4854 g/2.4698 g |
| Vessel 5 + 6 | Tablet 14.2 wt .-% (sample V1.5), |
| | 35 kN 2.5184 g/2.4838 g |

Filter for all vessel were changed after the 3^{th}, 6^{th}, 9^{th} and 12^{th} sampling. The release results are shown in FIG. 2.

### 3.6. Example 6—Efficacy Evaluation of Hydromagnesite Tablets Comprising Etofenprox Against Aphids

Two experiments were performed for the evaluation of the efficacy of the inventive delivery system in form of a tablet comprising hydromagnesite loaded with the insecticide etofenprox against aphids. In both trials the same material and experimental set up was used, only the number of treatments differed.

### Materials

Petri dishes
Filter papers
Tablets loaded with etofenprox (sample V2.3, 1.5 wt.-%, prepared according to Example 4)
Insecticide Blocker EC, commercially available from Omya Agro
Birchmeier Vaporizer 1.25 L
Surfactant Break-Thru commercially available from Omya Agro
Lettuce plants variety Lattich
Aphid species Myzus persicae

### Experimental Method

Pieces of leaves with an approximate size 3×3 cm were cut from lettuce plants; the pieces were taken from the centre of the leaves and they included part of the main vein. They were chosen to be flat or with at least as few folds as possible. Filter papers were placed on the bottom of petri dishes and were moistened with water through the whole experimental period to provide enough humidity to the leaves. One leaf piece was placed in the centre of each petri dish and ten aphids from already infested lettuce plants were transferred in each plate. Per treatment ten plates were prepared. The aphids were chosen to be in the first or second instar phase, so that the number of insects can stay constant through the whole trial period. One day after the infestation the tested solutions were applied on the dishes. Each tested solution was applied twice, one on the one side of the leaf and one on the other side. After the application the leaves were left to dry and then kept with their lids closed. Every day the water drops from the inside part of the lids ware removed and the filter papers were refreshed with water. The second day after the application the evaluation of the treatments started.

### Treatments

Treatment 1: Untreated check.
Treatment 2: Three tablets loaded with etofenprox (sample V2.3, 1.5 wt.-%, prepared according to Example 4)+0.05% Break-Thru (v/v based on the total amount of prepared treatment solution (solution amount: 131 ml, see below), resulting in 0.021 g active/tablet).
Treatment 3: Three unloaded hydromagnesite tablets+0.05% Break-Thru.
Treatment 4: Insecticide Blocker EC (appl. rate 0.5 l/ha, etofenprox active 288 gr/lt), used as positive control.

### Preparation of Test Solutions

Treatment 1: only water.
Treatment 2: In 131 ml of water 3 tablets were dissolved together with 0.05% Break-Thru. During the preparation of the spraying product, the loaded tablets disintegrated within 1 min in the water and the hydomagnesite powder precipitated very fast on the bottom of the tube. Before spraying with the Birchmeier vaporizer, the supernatant was separated from the precipitated hydromagnesite.
Treatment 3: In 131 ml of water 3 unloaded tablets were dissolved together with 0.05% Break-Thru.
Treatment 4: 250 μl Blocker were diluted in 150 ml of water. From this amount, 30 ml of solution were sprayed on 10 petri dishes.

### Application

10 petri dishes per treatment were placed on the floor and with the Birchmeier vaporizer sprayer, the tested products were applied. To be sure that the amount of active was the same among the treatments, the metronome application was used. The application of each treatment was done in both sides of each leaf. The evaluation was performed three times, 2 dpa (days past application), 5 dpa and 7 dpa.

### Results

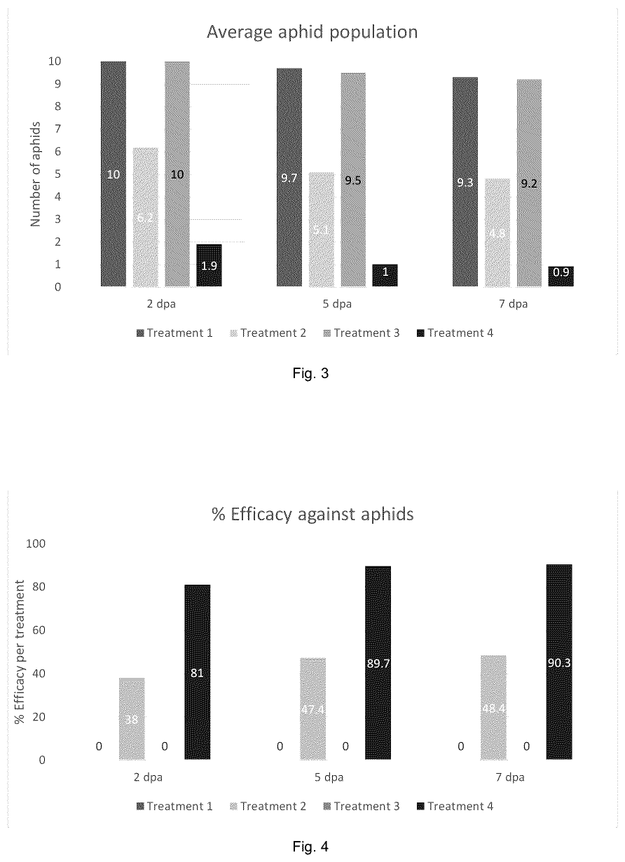

The population of aphids in the untreated check (treatment 1) stayed quite stable (above 9 alive aphids per dish) through the whole experimental period. Two days after application the average number of alive aphids in the positive control (treatment 4) was reduced by 81%, while in the treatment with the inventive tablet (treatment 2) the average number of alive aphids was reduced by 38%. The same trend was observed at 5 dpa and 7 dpa. For the unloaded tablet-treatment 3 the population did not decrease and the number of alive aphids was similar to the one of the untreated check (above 9 alive aphids per dish). The results are compiled in FIGS. 3 and 4.

### 3.7. Example 7—Efficacy Evaluation of Hydromagnesite Tablets Comprising Pyrimethanil Against Botrytis on Tomato Fruits

The following experiment was performed in order to evaluate the efficacy of hydromagnesite tablets loaded with the fungicide pyrimethanil against the pathogen Botrytis on tomato fruits.

### Materials

Tablets loaded with pyrimethanil (sample V3.3, 2.1 wt.-%, prepared according to Example 4)
Hydromagnesite tablets unloaded
Fungicide Espiro SC, commercially available from Omya Agro
Pure pyrimethanil powder, commercially available from Pluorochem Ltd
Five plastic trays with lids
Screwdriver
Eppendorf Pipette 10-100 μm
Tomato fruits (calibration 47-57 mm)
Inoculum: Spore suspension of Botrytis cinerea strain SAS 56 (3×10⁵ spores/ml), commercially available from DSMZ collection.

### Treatments

Treatment 1: Untreated check.
Treatment 2: Tablets loaded with pyrimethanil (sample V3.3, 2.1 wt.-%, prepared according to Example 4) (0.03 gr active/tablet).
Treatment 3: Unloaded hydromagnesite tablet.
Treatment 4: Fungicide Espiro (appl. rate 0.125% (v/v based on the total amount of prepared treatment solution (solution amount: 50 ml, see below), resulting in pyrimethanil active 400 gr/1).
Treatment 5: Pure pyrimethanil active diluted in ethanol of 99% purity.

### Preparation of Test Solutions

Treatment 1: Only inoculum applied
Treatment 2: In 50 ml of water 1 tablet was dissolved. During the preparation of the spraying product, the loaded tablet disintegrated within 1 min in the water and the hydromagnesite powder precipitated very fast on the bottom of the tube.
Treatment 3: In 50 ml of water 1 unloaded tablet was dissolved. The same observations were made as treatment 2.
Treatment 4: In 50 ml of water 62.5 μl of the commercial product Espiro were dissolved.
Treatment 5: In 50 ml of ethanol 99% 30 mg of pure pyrimethanil active were dissolved.

### Application

Ten tomato fruits were used per treatment. The tomatoes were disinfected with ethanol and placed upside down on a plastic tray. A screwdriver was used to puncture the skin of the fruits creating a hole. This procedure was repeated four times on the bottom side of each fruit creating holes with the same size and depth in each tomato and among all treatments. After completing the injuring of the skin in all fruits, each hole was filled with 80 μl of test solution by using an Eppendorf pipette. This process was repeated in every treatment, except the untreated. All treatments received the same amount of active, so that the results can be comparable. The fungicide-droplets were allowed to dry and one day later the inoculum was applied in the same way (pipetting 80 μl of inoculum suspension). From that time, the four trays each containing one treatment were covered with a lid and the paper at the bottom of each tray was kept wet to provide sufficient humidity for the growth of the fungal spores.

### Results

Three days after the inoculation the first symptoms in the untreated check were detected. Only one evaluation took place and this happened 6 days after the inoculation (dpi), when the morphology of the mycelium was the typical one of the Botrytis pathogen (grey mould). The assessment was done visually, and the disease incidence scoring was: from 100% when all the holes of the fruits showed mycelian growth to 0% when there was no growth.

From the above results it is shown that in the untreated check (treatment 1), where only inoculum was applied, the success in the infection was 100%, while in the treatments where active was applied in the form of tablet (treatment 2), commercial product (treatment 4) and pure active agent (treatment 5), prior to the inoculation, the fungal spores didn't germinate, and no mycelium was produced. The unloaded hydromagnesite tablet (treatment 3), however showed 100% infection by Botrytis.

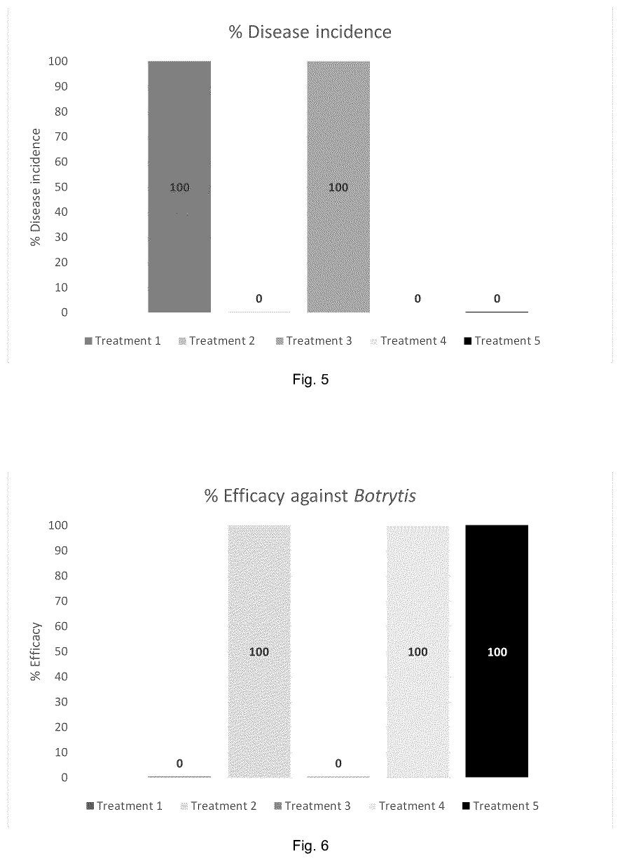

The evaluation (6 dpi) showed that the loaded tablets performed equally well, when compared with the commercial product Espiro and the pure active pyrimethanil. The present efficacy trial clearly proved that by disintegration of the tablets in the water the loaded active pyrimethanil was released and its activity maintained during the inoculation process, since none of the Botrytis spores was able to grow despite the favourable conditions during the experiment. One more positive observation was that by the disintegrating process the loaded tested tablet dissolved completely in the water (within a minute) and the hydromagnesite carrier precipitated on the bottom of the bottle as a fine powder, leaving the supernatant free from the small particles. One last observation is that the hydromagnesite powder (unloaded tablet) could not prevent the growth of the pathogen. The results are presented in FIGS. 5 and 6.

### 3.8. Example 8—Efficacy Evaluation of Hydromagnesite Tablets Comprising 2,4-D Against Mustard Plants

Aim of this experiment was to evaluate the efficacy of hydromagnesite tablets loaded with the herbicide 2,4-D against mustard plants.

### Material

20 trays with dimensions: 17×27×6 cm each.
Compo Sana Kultursubstrate
Mustard Seeds: Saatsenf, commercially available from Mauser (Sinapsis alba)
Birchmeier Vaporizer 1.25 L
Tablets loaded with 2,4-D (sample V1.3, 6.1 wt.-%, prepared according to Example 4)
Unloaded hydromagnesite tablets
2,4-D flüssig, commercially available from Omya
Surfactant Break-Thru

### Treatments

Treatment 1: Untreated check—only water.
Treatment 2: Three tablets loaded with 2,4-D (sample V1.3, 6.1 wt.-%, prepared according to Example 4) (0.085 gr active/tablet)+0.05% Break-Thru.
Treatment 3: Three unloaded hydromagnesite tablets+0.05% Break-Thru (v/v based on the total amount of prepared treatment solution (solution amount: 112 ml, see below).
Treatment 4: Commercial product 2,4-D flüssig (appl. rate 21/ha and 400 gr active/l).

### Experimental Method

Each tray was filled with soil and sown with 3.5 gr of seeds from the plant species Sinapsis alba (common mustard). All 20 trays were kept under greenhouse conditions and watered regularly. After germination of the seeds and when the plants reached the early real leaves stage (immediately after the cotyledon leaves), the application of the three treatments took place. The tested products were applied only once.

### Preparation of Test Solutions

Treatment 1: only water.
Treatment 2: In 112 ml of water 3 tablets were dissolved together with 0.05% Break-Thru. From this amount, 35 ml of solution were sprayed on 5 trays. During preparation of the spraying product, the loaded tablets disintegrated totally in the water and the hydromagnesite powder precipitated very fast on the bottom of the tube.
Treatment 3: In 112 ml of water 3 unloaded tablets were dissolved together with 0.05% Break-Thru.
Treatment 4: In 105 ml of water 0.6 ml of 2,4-D flüssig were diluted. From this amount, 35 ml of solution were sprayed on 5 trays.

### Application

Five trays per treatment were placed on the floor and with the Birchmeier vaporizer sprayer, the tested products were applied. In order to spray the same amount of solution per treatment, the Metronome application was used. In treatment 2 and 4 the same amount of the active ingredient 2,4-D was applied on the experimental surface. In treatment 2 and treatment 3 no congestion of nozzles was observed and no staining on the leaves. The analysis was done 4 days after the application (4 dpa). Photos were taken with a camera (individually for each tray), using a standard height and standard focus, before and after the application. All photos were later analysed using the image processing program ImageJ, where the percentage of green area and the growth of the plants was evaluated.

### Results

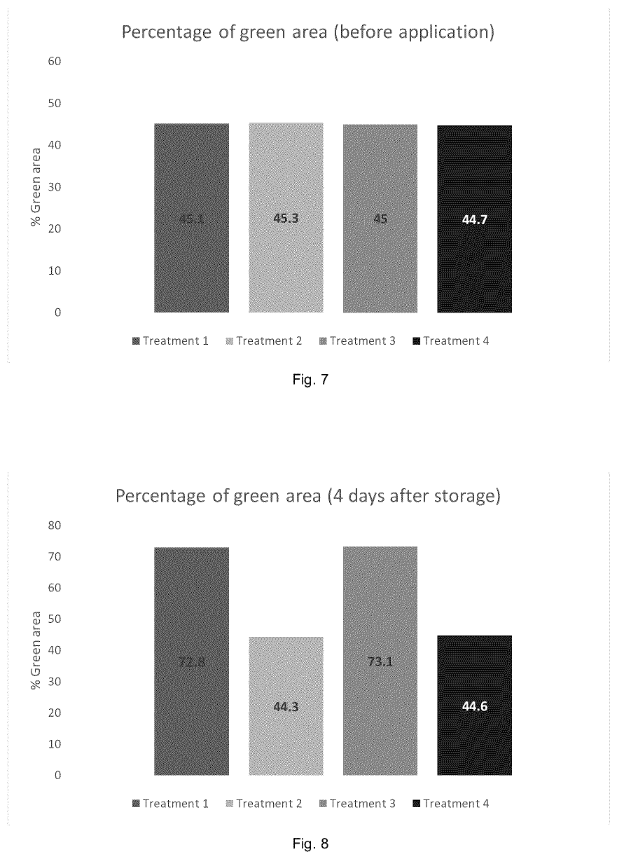

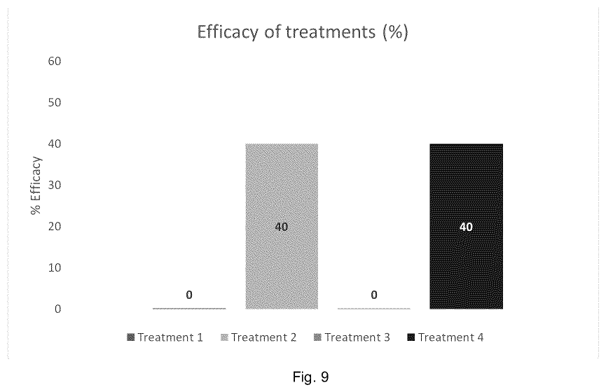

Before application all the treatments had similar growth, showed by the same percentages of green area among the treatments. Four days after the application, the % of green area increased by 61.37% in the untreated treatment 1, while in the loaded tablet-treatment (treatment 2) the plants had no additional growth, plus they showed a decrease in the percentage of green area of 2.15%. The same trend was observed in the positive control treatment (treatment 4), where the plants missed the additional growth and the green area was reduced by 0.11%. In terms of efficacy of the product, both treatments, 2 and 4, showed similar efficacy against mustard plants. Treatment 3 showed no herbicide-effect against the mustard plants. The results are shown in FIGS. 7, 8, and 9.

All trays in the beginning of the experiment were in the same developmental stage which was an important factor, since the sensitivity of the plants against the herbicides is depended, among other parameters, on their growth stadium. Four days after applying the test solution prepared from the inventive tablets (treatment 2), it not only noticed a stop in the growth of the plants but also a reduction in the green leaf area was observed. The same was observed for the commercial product, 2,4-D flüssig. The efficacy of both treatments, tablet and commercial product, reached the levels of 40%. The test solution prepared from the unloaded hydromagnesite tablets did not show any effect against mustard plants (treatment 3).

For both loaded and unloaded-tablet applications, 3 tablets were dissolved in water. The disintegration happened within a minute and no course particles were noticed. Additionally, despite the relatively high amount of hydromagnesite powder precipitated on the bottom of the sprayer, there was no congestion of nozzle of the sprayer during applying the tested product. Regarding the loaded active in the tablets it can be concluded from the results that 2,4-D was released in the solution and its effectiveness was maintained during the application of the product on the leaves.

1. A delivery system comprising
a first hydromagnesite, wherein the first hydromagnesite is an unloaded hydromagnesite, and
a second hydromagnesite, wherein the second hydromagnesite is loaded with at least one active agent.

2. The delivery system of claim 1, wherein the first hydromagnesite and/or the second hydromagnesite has a specific surface area in the range from 25 to 150 m²/g, measured using nitrogen and the BET method according to ISO 9277:2010.

3. The delivery system of claim 1, wherein the first hydromagnesite and/or the second hydromagnesite has an intra-particle intruded specific pore volume in the range from 0.9 to 2.3 cm³/g, calculated from mercury porosimetry measurement.

4. The delivery system of claim 1, wherein
the first hydromagnesite and/or the second hydromagnesite has a volume determined median particle size d₅₀ from 1 to 75 μm, and/or
the first hydromagnesite and/or the second hydromagnesite has a volume determined top cut particle size d₉₈ from 2 to 150 μm.

5. The delivery system of claim 1, wherein the first hydromagnesite and the second hydromagnesite are independently selected from the group consisting of ground natural hydromagnesite, precipitated hydromagnesite, surface-treated hydromagnesite, and mixtures thereof.

6. The delivery system of claim 1, wherein the at least one active agent is adsorbed onto and/or adsorbed and/or absorbed into the second hydromagnesite.

7. The delivery system of claim 1, wherein the at least one active agent is an agrochemical active agent or a precursor thereof; selected from fungicides, herbicides, insecticides, miticides, acaricides, nematicides, bactericides, rodenticides, molluscicides, avicides, repellents, attractants, biocontrol agents, soil additives, fertilizers, micronutrients, phytohormones, biostimulants, or mixtures thereof.

8. The delivery system of claim 1, wherein the second hydromagnesite is loaded with at least 1 wt.-% of at least one active agent, based on the total weight of the second hydromagnesite.

9. The delivery system of claim 1, wherein the first hydromagnesite is present in an amount from 1 wt.-% to 99 wt.-% based on the total weight of the delivery system, and
wherein the second hydromagnesite is present in an amount from 1 wt.-% to 99 wt.-%, based on the total weight of the delivery system.

10. The delivery system of claim 1, wherein the delivery system further comprises a disintegration agent.

11. The delivery system of claim 1, wherein the delivery system is in the form of a powder, a tablet, a pellet a bar, or granules.

12. A method of using a delivery system according to claim 1 in an agricultural application comprising the step of applying the delivery system to an area to control growth of a target plant.

13. An agricultural formulation comprising a delivery system according to claim 1.

14. A method for preparing a delivery system according to claim 1, wherein the method comprises the steps of:
a) providing a first hydromagnesite, wherein the first hydromagnesite is an unloaded hydromagnesite,
b) providing a second hydromagnesite, wherein the second hydromagnesite is loaded with at least one active agent,
c) mixing the first hydromagnesite and the second hydromagnesite, and
d) optionally compacting the mixture obtained in step c).

15. The method of claim 14, wherein the second hydromagnesite is prepared by the following steps:
i) providing unloaded hydromagnesite,
ii) providing at least one active agent, and
iii) contacting the unloaded hydromagnesite of step i) with the at least one active agent of step ii) to form a hydromagnesite that is loaded with at least one active agent.

16. The delivery system of claim 3, wherein the first hydromagnesite and/or the second hydromagnesite has an intra-particle intruded specific pore volume in the range from 1.2 to 2.0 cm³/g, calculated from mercury porosimetry measurement.

17. The delivery system of claim 7, wherein the at least one active agent is selected from pyrimethanil, 2,4-D, etofenprox, and mixtures thereof.

18. The delivery system of claim 10, wherein the disintegration agent is selected from the group consisting of modified cellulose gum, insoluble cross-linked polyvinylpyrrolidone, starch glycolate, micro crystalline cellulose, pregelatinized starch, sodium carboxymethyl starch, low-substituted hydroxypropyl cellulose, homopolymer of N-vinyl-2-pyrrolidone, alkyl-, hydroxyalkyl-, carboxyalkyl-cellulose ester, alginate, microcrystalline cellulose, ion exchange resin, chitin, chitosan, clay, gellan gum, crosslinked polacrillin copolymers, agar, gelatin, dextrin, acrylic acid polymer, cross-linked carboxymethylcellulose, carboxymethylcellulose salt, hydroxpropyl methyl cellulose phthalate, shellac, starch, and mixtures thereof.

19. The delivery system of claim 18, wherein the disintegration agent is croscarmellose salt.

20. The delivery system of claim 11, wherein the delivery system is in the form of an effervescent tablet or fast disintegrating tablet.
